(19) United States
(12) Patent Application Publication
(10) Pub. No.: US 2013/0144583 A1
(43) Pub. Date: Jun. 6, 2013

(54) HYPER-DIMENSIONAL SIMULATION FOR RESERVOIR ENGINEERING AND GEOSCIENCES

(71) Applicants: Kesavalu Hemanthkumar, Dhahran (SA); Nabil M. Al Zamel, Dhahran (SA); Ali H. Dogru, Dhahran (SA); Abdulaziz Al Baiz, Dammam (SA)

(72) Inventors: Kesavalu Hemanthkumar, Dhahran (SA); Nabil M. Al Zamel, Dhahran (SA); Ali H. Dogru, Dhahran (SA); Abdulaziz Al Baiz, Dammam (SA)

(73) Assignee: Saudi Arabia Oil Company, Dhahran (SA)

(21) Appl. No.: 13/590,916

(22) Filed: Aug. 21, 2012

Related U.S. Application Data
(60) Provisional application No. 61/530,742, filed on Sep. 2, 2011.

(51) Int. Cl. G06F 17/50

(52) U.S. Cl. CPC G06F 17/5009
USPC 703/10

(57) ABSTRACT

A hyper-dimensional simulator performs petroleum reservoir engineering and geosciences in a spatial volume operating environment. The entire spatial volume is ‘active’ for reservoir and geosciences applications. Although points in 3-D space are available for reservoir engineering and geosciences functions, it is conceptually easier to work with virtual, that is hyper dimensional surfaces and media. Limitations of single channel input using the mouse and/or keyboard imposed by prior art methods.

### CROSS-REFERENCE TO RELATED APPLICATIONS

This application claims priority and is related to U.S. Provisional Patent Application No. 61/530,742 filed Sep. 2, 2011 titled, “HYPER-DIMENSIONAL SIMULATION SYSTEM FOR RESERVOIR ENGINEERING AND GEOSCIENCES.”

### BACKGROUND OF THE INVENTION

1. Field of the Invention

The present invention herein relates to greatly expanding access to and from data in computer systems regarding subsurface hydrocarbon reservoirs, and thereby comprehensively enhancing the modeling and simulation capabilities for reservoir engineering and geosciences and provide optimal production of oil and gas from hydrocarbon reservoirs.

2. Description of the Related Art

High resolution reservoir engineering and geosciences of large oil and gas reservoirs to optimize oil and gas recovery has required comprehensive access to data and simulation. In the area of mathematical simulation of the hydrocarbon recovery process great progress has been made in recent years by the assignee of the present invention. Reservoir simulators known as POWERS and GigaPOWERS have been described in the literature. See, for example articles by Dogru, A. H., et al.: “A Parallel Reservoir Simulator for Large-Scale Reservoir Simulation,” SPE Reservoir Evaluation & Engineering Journal, pp. 11-23, 2002, by Dogru, A. H. et al., “A Next-Generation Parallel Reservoir Simulator for Giant Reservoirs,” SPE 119272, proceedings of the 2009 SPE Reservoir Simulation Symposium, The Woodlands, Tex., USA, Feb. 2-4, 2009 and by Dogru, A. H., Fung, L. S., Middya, U., Al-Shaalan, T. M., Byer, T., Hoy, H., Hahn, W. A., Al-Zamel, N., Pita, J., Hemanthkumar, K., Mezghani, M., Al-Mana, A., Tan, J, Dreiman, T., Fugl, A, Al-Baiz, A., “New Frontiers in Large Scale Reservoir Simulation,” SPE142297, Proceedings of the 2011 SPE Reservoir Simulation Symposium, The Woodlands, Texas, USA, Feb. 21-23, 2011.

Reservoir simulators such as POWERS and GigaPOWERS (the oil and gas industry's first billion cell reservoir simulator), both developed by the assignee of the present invention, now provide the capability of modeling the large oil and gas fields more accurately and thus increase confidence in predicting the deliverability and recoverable reserves, reservoir management of existing fields, and development of new and existing fields. The reservoir simulation engineering and geosciences of the large fields require the analysis, visualization of ultra large amounts of data.

In a typical field development or field upgrade project, geoscientists have used well test data, core data, geologic deposition understanding guided by seismic data and other data, complemented by theoretical geologic spatial property distribution knowledge to develop a 3-D geologic model of the field on the computer. The prior art building of the 3-D geologic model has been done by interacting with the computer using a single channel communication by conventional computer inputs, such as a keyboard and/or a mouse.

An example reservoir of the type for which production data are simulated over the expected reservoir life as illustrated by the model M is usually one which is known to those in the art as a giant reservoir. A giant reservoir may be several miles in length, breadth and depth in its extent beneath the earth and might, for example, have a volume or size on the order of three hundred billion cubic feet. For giant reservoirs, the sheer volume of the data involved became a problem in simulation and analysis of performance over a period of time.

In addition, the increased accuracy of detailed seismic-data which samples the reservoir at 25-meter areal (x and y) intervals, has begun to demand models of hundreds of millions to billions of cells to assimilate all the available detail, which in turn has been intended to result in more accurate predictions over the life of the reservoir and lead to higher ultimate oil and gas recovery.

The reservoir simulation engineer received the 3-D geologic model of the field and used this model as the basis to build a flow simulation model. With the advent of reservoir simulators such as POWERS and GigaPOWERS, the engineer typically used the full detail of the geologic model in the hydrocarbon area of the field while up-scaling the aquifer area of the field. Normally the layering of the model was preserved for detailed models. The prior art building of the reservoir simulation model has, so far as is known, been done by interacting with the computer using a single channel input such as the keyboard and/or the mouse.

### SUMMARY OF THE INVENTION

Briefly, the present provides a data processing system for computerized simulation of reservoir data regarding a subsurface reservoir for reservoir engineering and geosciences analysis in response to commands communicated by a user. The data processing system includes a data memory containing reservoir data information for the reservoir being simulated, and a viewing station sensing commands from the user for display of selected portions of the reservoir data. A processor in the data processing system receives the selected portions of the reservoir data from the data memory based on the commands from the user, and transfers the selected portions of the reservoir data from the processor based on the commands from the user. An output display receives the transferred selected portions of the reservoir data from the processor and forms an output image of the transferred selected portions of the reservoir data based on the commands from the user.

The present invention also provides a computer implemented method of computerized simulation in a computer system which includes a processor, a data memory, a user interface and an output display. The computerized simulation implemented performed is of reservoir data regarding a subsurface reservoir for reservoir engineering and geosciences analysis in response to commands communicated by a user. According to the computerized simulation with the present invention, reservoir data information for the reservoir being simulated is stored in the data memory. Commands from the user for display of selected portions of the reservoir data are sensed in the viewing station. The selected portions of the reservoir data from the data memory are received in the processor based on the commands from the user. The selected portions of the reservoir data received from the processor are transferred to the output display based on the commands from the user, and an output image of the transferred selected portions of the reservoir data is formed in the output display based on the commands from the user.

The present invention also provides data storage device which has stored in a non-transitory computer readable medium computer operable instructions for causing a data processing system comprising a processor, a data memory, a user interface and an output display to perform computerized simulation of reservoir data regarding a subsurface reservoir for reservoir engineering and geosciences analysis in response to commands communicated by a user. The data processing system in which the stored computer operable instructions are performed includes a processor, a data memory, a user interface and an output display. The instructions stored in the data storage device causing the data processing system to store in the data memory reservoir data information for the reservoir being simulated. The instructions cause the data processing system to sense in the viewing station commands from the user for display of selected portions of the reservoir data, and receive in the processor the selected portions of the reservoir data from the data memory based on the commands from the user. The instructions also cause the data processing system to transfer to the output display the selected portions of the reservoir data received from the processor based on the commands from the user, and to form in the output display an output image of the transferred selected portions of the reservoir data based on the commands from the user.

### BRIEF DESCRIPTION OF THE DRAWINGS

A better understanding of the present invention can be obtained when the detailed description set forth below is reviewed in conjunction with the accompanying drawings.

FIGS. 1A, 1B and 1C are schematic diagrams which illustrate navigation or traversing movement of a reservoir image on a display according to the present invention in a horizontal plane from east to west in response to a pose or gesture by a user.

FIGS. 2A, 2B and 2C are schematic diagrams which illustrate navigation or traversing movement from front to back of a reservoir image on a display according to the present invention in response to a pose or gesture by a user.

FIGS. 3A, 3B and 3C are schematic diagrams which illustrate navigation or traversing movement of a reservoir image on a display according to the present invention in a vertical plane from south to north in response to a pose or gesture by a user.

FIGS. 4A, 4B and 4C are schematic diagrams which illustrate panning or rotational movement in a horizontal plane along a vertical axis of a reservoir image on a display according to the present invention in response to a pose or gesture by a user.

FIGS. 5A, 5B and 5C are schematic diagrams which illustrate tilting or rotational movement in a horizontal plane along the X-direction axis of a reservoir image on a display according to the present invention in response to a pose or gesture by a user.

FIGS. 6A, 6B and 6C are schematic diagrams which illustrate rolling or rotational movement in a horizontal plane along the Y-direction axis of a reservoir image on a display according to the present invention in response to a pose or gesture by a user.

FIGS. 7A, 7B and 7C are schematic diagrams which illustrate restoration of an image of the reservoir to its initial state from an adjusted state to which the image had been moved in response to a pose or gesture by a user.

FIGS. 8A, 8B and 8C are schematic diagrams which illustrate application or placement of a simulation grid on a reservoir image on a display according to the present invention in response to a pose or gesture by a user.

FIGS. 9A, 9B and 9C are schematic diagrams which illustrate removal or deletion of a simulation grid on a reservoir image from a display according to the present invention in response to a pose or gesture by a user.

FIGS. 10A, 10B and 10C are schematic diagrams which illustrate a request for display of a well at a selected area or region of a reservoir by hand gestures taken with respect to a virtual surface image display of reservoir data according to the present invention.

FIGS. 11A, 11B and 11C are schematic diagrams which illustrate a hand gesture action with respect to a virtual surface image display to focus or lock in the selected well in the virtual surface image display of reservoir data according to the present invention.

FIGS. 12A, 12B and 12C are schematic diagrams which illustrate a request for display of several wells at a selected area or region of a reservoir by hand gestures taken with respect to a virtual surface image display of reservoir data according to the present invention.

FIGS. 13A, 13B and 13C are schematic diagrams which illustrate a hand gesture action with respect to a virtual surface image display to focus or lock in a selected group of wells in the virtual surface image display of reservoir data according to the present invention.

FIGS. 14A, 14B and 14C are schematic diagrams which illustrate the movement through a reservoir image of a geological layer or model in a display according to the present invention in response to a pose or gesture by a user.

FIGS. 15A, 15B and 15C are schematic diagrams which illustrate the movement through X-direction cross-sections of a geological layer or model in a display according to the present invention in response to a pose or gesture by a user.

FIGS. 16A, 16B and 16C are schematic diagrams which illustrate the movement through Y-direction cross-sections of a geological layer or model in a display according to the present invention in response to a pose or gesture by a user.

FIGS. 17A, 17B, 17 C and 17D are schematic diagrams which illustrate selection of a model/geologic layer in a virtual display mode on a virtual display surface according to the present invention in response to a pose or gesture by a user.

FIGS. 18A, 18B, 18C and 18D are schematic diagrams which illustrate selection of an X-direction cross-section mode on a virtual display surface according to the present invention in response to a pose or gesture by a user.

FIGS. 19A, 19B, 19C and 19D are schematic diagrams which illustrate selection of a Y-direction cross-section mode on a virtual display surface according to the present invention in response to a pose or gesture by a user.

FIGS. 20A, 20B and 20C are schematic diagrams which illustrate selection of a measure or parameter of interest for presentation in a display according to the present invention in response to a pose or gesture by a user.

FIGS. 21A, 21B and 21C are schematic diagrams which illustrate selection of another measure or parameter of interest for presentation in a display according to the present invention in response to a pose or gesture by a user.

FIGS. 22A, 22B and 22C are schematic diagrams which illustrate selection of a measure or parameter of interest for presentation in a display according to the present invention in response to a pose or gesture by a user.

FIGS. 23A, 23B and 23C are schematic diagrams which illustrate selection of a measure or parameter of interest for presentation in a display according to the present invention in response to a pose or gesture by a user.

FIGS. 24A, 24B and 24C are schematic diagrams which illustrate a display according to the present invention in response to a pose or gesture by a user to permit observation of changes in the reservoir as a function of time as a result of production and injection.

FIGS. 25A, 25B and 25C are schematic diagrams which illustrate a display according to the present invention in response to a pose or gesture by a user to permit observation of properties of the reservoir at a selected time.

FIGS. 26A, 26B and 26C are schematic diagrams which illustrate highlighting a well path for presentation in a display according to the present invention in response to a pose or gesture by a user.

FIGS. 27A, 27B and 27C are schematic diagrams which illustrate selection of a measure or parameter of interest in the area of a selected well path for presentation in a display according to the present invention in response to a pose or gesture by a user.

FIGS. 28A, 28B and 28C are schematic diagrams which illustrate picking a well in the reservoir from a display of a reservoir.

FIGS. 29A, 29B and 29C are schematic diagrams which illustrate an action to re-locate a picked well in a display of a reservoir.

FIGS. 30A, 30B and 30C are schematic diagrams which illustrate a hand gesture action to write the new location of a re-located well to a computer memory file.

FIGS. 31A, 31B and 31C are schematic diagrams which illustrate a hand gesture action to pick from a display several wells in a region of a reservoir.

FIGS. 32A, 32B and 32C are schematic diagrams which illustrate a hand gesture action to re-locate a picked group of wells in a reservoir.

FIGS. 33A, 33B and 33C are schematic diagrams which illustrate a hand gesture action to write new locations of re-located wells to a computer memory file.

FIGS. 34A, 34B and 34C are schematic diagrams which illustrate a hand gesture action to start a reservoir simulation from a time of relocation of a well or group of wells in the reservoir display.

FIGS. 35A, 35B and 35C are schematic diagrams which illustrate a hand gesture action to update reservoir simulation results in computer memory.

FIGS. 36A, 36B and 36C are schematic diagrams which illustrate preparation for a well re-design in a reservoir according to the present invention.

FIGS. 37A, 37B and 37C are schematic diagrams which illustrate the preparation for a well design in a reservoir display from scratch according to the present invention.

FIGS. 38A, 38B and 38C are schematic diagrams which illustrate the re-design of the well on a hyper-dimensional surface according to the present invention.

FIGS. 39A, 39B and 39C are schematic diagrams which illustrate return of a re-designed well back to a parent reservoir on a display screen according to the present invention.

FIGS. 40A, 40B and 40C are schematic diagrams which illustrate design of a well from scratch on a hyper-dimensional surface according to the present invention.

FIGS. 41A, 41B and 41C are schematic diagrams which illustrate the return of the newly designed well from a hyper-dimensional surface back to a parent reservoir on a display screen according to the present invention.

FIGS. 42A, 42B and 42C are schematic diagrams which illustrate the placement of a physical object representing a vertical well on a hyper-dimensional surface according to the present invention.

FIGS. 43A, 43B and 43C are schematic diagrams which illustrate the placement of a physical object representing a horizontal well on a hyper-dimensional surface according to the present invention.

FIGS. 44A, 44B and 44C are schematic diagrams which illustrate the placement of a physical object representing one of several designs of a multi-lateral well on a hyper-dimensional surface according to the present invention.

FIGS. 45A, 45B and 45C are schematic diagrams which illustrate the translation of the placement of a physical object on a hyper-dimensional surface to a model of the reservoir for simulation according to the present invention.

FIG. 46 illustrates concurrent local collaboration between a reservoir engineer and geo scientist in the initial design of a well according to the present invention.

FIGS. 47A and 47B are schematic diagrams which illustrate concurrent local and remote collaboration according to the present invention between a reservoir engineer and geoscientist (local) and a drilling foreman (remote) in the field studying the characteristics of the well to be drilled.

FIGS. 48A and 48B are schematic diagrams which illustrate concurrent local and remote collaboration between a reservoir engineer and geoscientist (local) and a production engineer (remote) in a satellite office studying a work-over scenario according to the present invention to manage water production from wells.

FIGS. 49A, 49B and 49C are schematic diagrams which illustrate navigation of a reservoir image in a horizontal plane from east to west using the dimension of voice according to the present invention.

FIGS. 50A, 50B and 50C are schematic diagrams which illustrate navigation of a reservoir image in a vertical plane from south to north using the dimension of voice according to the present invention.

FIGS. 51A, 51B and 51C are schematic diagrams which illustrate navigation of a reservoir image from front to back using the dimension of voice according to the present invention.

FIGS. 52A, 52B and 52C are schematic diagrams which illustrate panning a reservoir image in a display using the dimension of voice according to the present invention.

FIGS. 53A, 53B and 53C are schematic diagrams which illustrate tilting a reservoir image in a display to observe a part of the reservoir that was previously not visible using the dimension of voice according to the present invention.

FIGS. 54A, 54B and 54C are schematic diagrams which illustrate roll navigation of a reservoir image to enter the reservoir to give an immersive effect using the dimension of voice according to the present invention.

FIGS. 55A, 55B and 55C are schematic diagrams which illustrate a voice command to restore an image of a reservoir to its initial state using the dimension of voice according to the present invention.

FIGS. 56A, 56B and 56C are schematic diagrams which illustrate a voice command to cause drawing of a simulation grid on a reservoir model according to the present invention.

FIGS. 57A, 57B and 57C are schematic diagrams which illustrate a voice command to cause removal of a simulation grid from a reservoir model according to the present invention.

FIGS. 58A, 58B and 58C are schematic diagrams which illustrate a voice command to select a well from a reservoir display according to the present invention.

FIGS. 59A, 59B and 59C are schematic diagrams which illustrate a voice command to select several wells in a region from a reservoir display according to the present invention.

FIGS. 60A, 60B and 60C are schematic diagrams which illustrate a voice command to cause display of model/geologic layers from a reservoir model one at a time until all the layers are traversed according to the present invention.

FIGS. 61A, 61B and 61C are schematic diagrams which illustrate a voice command to cause display of model/geologic X-direction cross-sections from a reservoir model one at a time until all the X-direction cross-sections are traversed according to the present invention.

FIGS. 62A, 62B and 62C are schematic diagrams which illustrate a voice command to cause display of model/geologic Y-direction cross-sections from a reservoir model one at a time until all the Y-direction cross-sections are traversed according to the present invention.

FIGS. 63A, 63B and 63C are schematic diagrams which illustrate a voice command to cause display of a called-out model/geologic layer from a reservoir model according to the present invention.

FIGS. 64A, 64B and 64C are schematic diagrams which illustrate a voice command to cause display of a called-out model/geologic X-direction cross-section from a reservoir model according to the present invention.

FIGS. 65A, 65B and 65C are schematic diagrams which illustrate a voice command to cause display of a called-out model/geologic Y-direction cross-section from a reservoir model according to the present invention.

FIGS. 66A, 66B and 66C are schematic diagrams which illustrate a voice instruction to select data regarding ternary saturation of oil-gas-water for display to examine the current state of a reservoir with respect to its ternary saturation according to the present invention.

FIGS. 67A, 67B and 67C are schematic diagrams which illustrate a voice instruction to select porosity distribution data for display to examine the current state of a reservoir with respect to its porosity according to the present invention.

FIGS. 68A, 68B and 68C are schematic diagrams which illustrate a voice instruction to select permeability distribution data for display to examine the current state of a reservoir with respect to its permeability according to the present invention.

FIGS. 69A, 69B and 69C are schematic diagrams which illustrate a voice instruction to select another property of the reservoir for display according to the present invention.

FIGS. 70A, 70B and 70C are schematic diagrams which illustrate a voice instruction to cause displays of reservoir models at specified times according to the present invention to observe changes in a reservoir as a function of time as a result of production and injection.

FIGS. 71A, 71B and 71C are schematic diagrams which illustrate a voice instruction to advance a specified time step to pause and observe the properties of a reservoir at a selected time step according to the present invention.

FIGS. 72A, 72B and 72C are schematic diagrams which illustrate a voice instruction to highlight a well path in a display of a reservoir model according to the present invention.

FIGS. 73A, 73B and 73C are schematic diagrams which illustrate a voice instruction to select a ternary saturation of oil-gas-water to be displayed in connection with a highlighted well path in a reservoir model according to the present invention to examine the current state of production from the well.

FIGS. 74A, 74B and 74C are schematic diagrams which illustrate a voice instruction to re-locate a picked well in a reservoir model according to the present invention.

FIGS. 75A, 75B and 75C are schematic diagrams which illustrate a voice instruction to write a new location and related properties of a re-located well to a computer memory file according to the present invention.

FIGS. 76A, 76B and 76C are schematic diagrams which illustrate a voice instruction to pick a group of several wells in a region of a reservoir from a reservoir model according to the present invention.

FIGS. 77A, 77B and 77C are schematic diagrams which illustrate a voice instruction to re-locate a group of picked wells in a region of a reservoir according to the present invention.

FIGS. 78A, 78B and 78C are schematic diagrams which illustrate a voice instruction to write new locations and related properties of a group of re-located wells to a computer memory file according to the present invention.

FIGS. 79A, 79B and 79C are schematic diagrams which illustrate a voice instruction to start a reservoir simulation from a time of relocation of the wells in a reservoir model according to the present invention.

FIGS. 80A, 80B and 80C are schematic diagrams which illustrate a voice instruction to update reservoir simulation results in computer memory file according to the present invention.

FIGS. 81A, 81B and 81C are schematic diagrams which illustrate preparation for a well re-design in a reservoir model according to the present invention.

FIGS. 82A, 82B and 82C are schematic diagrams which illustrate preparation for a well design from scratch in a reservoir model according to the present invention.

FIGS. 83A, 83B and 83C are schematic diagrams which illustrate the re-design of a well on a hyper-dimensional surface according to the present invention.

FIGS. 84A, 84B and 84C are schematic diagrams which illustrate the return of a re-designed well back from a hyper-dimensional surface to the parent reservoir on a computer display screen according to the present invention.

FIGS. 85A, 85B and 85C are schematic diagrams which illustrate design of a well from scratch on a hyper-dimensional surface according to the present invention.

FIGS. 86A, 86B and 86C are schematic diagrams which illustrate return of a newly designed well back from a hyper-dimensional surface to the parent reservoir on a computer display screen according to the present invention.

FIG. 87 is functional block diagram of a set of data processing steps performed in the computer system according to the present invention for hyper-dimensional simulation of reservoir data.

FIGS. 88 and 89 are schematic diagrams of a computer system according to the present invention for hyper-dimensional simulation of reservoir data.

### DETAILED DESCRIPTION OF THE PREFERRED EMBODIMENTS

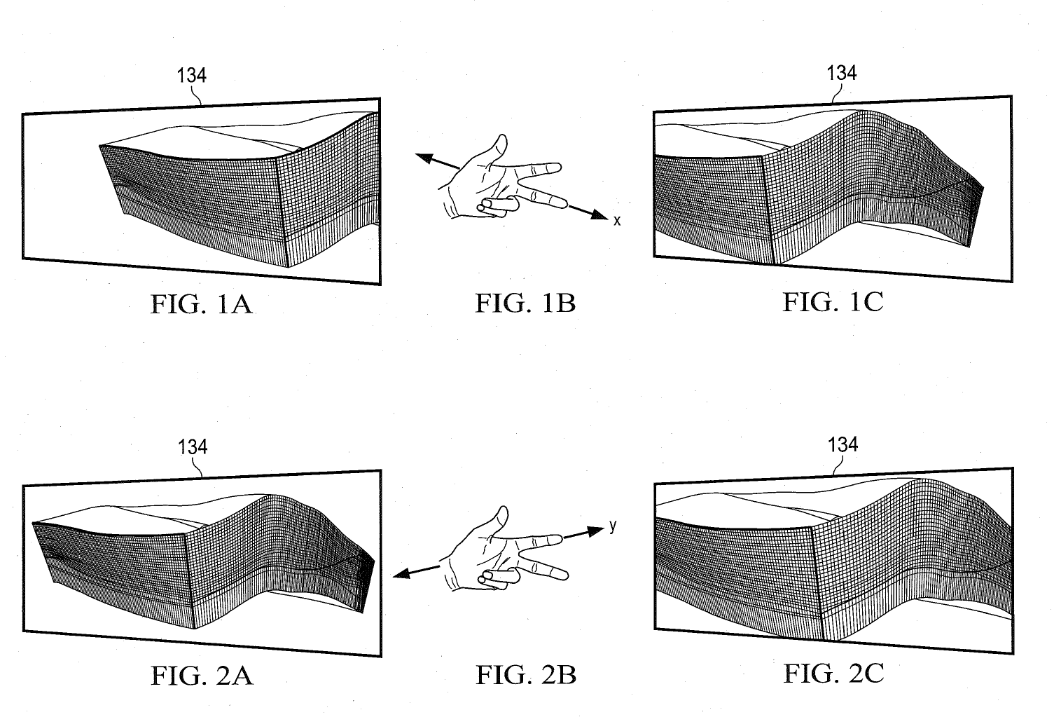

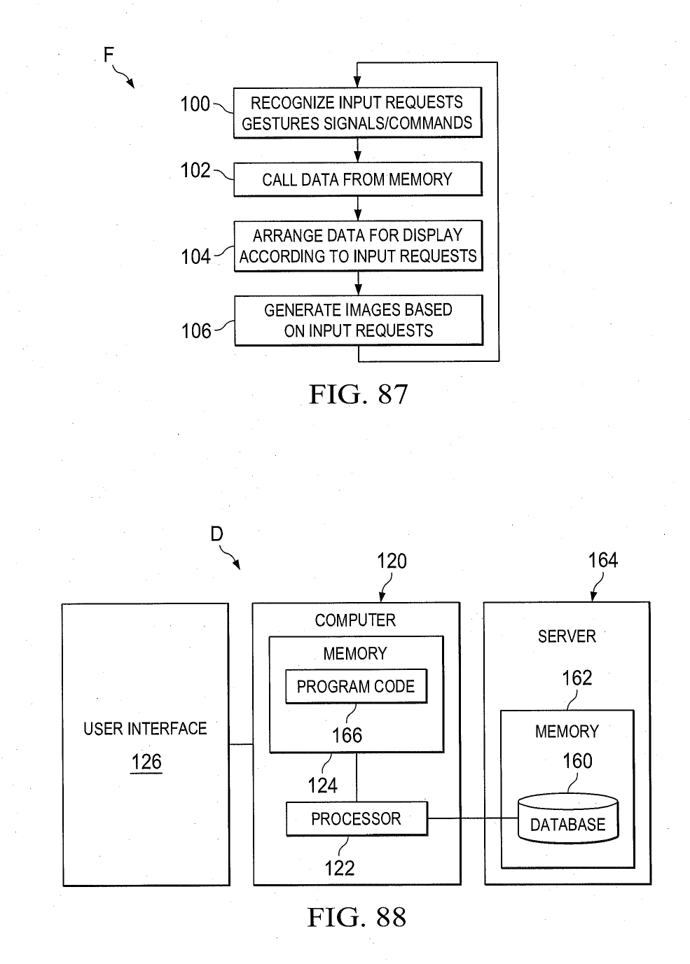

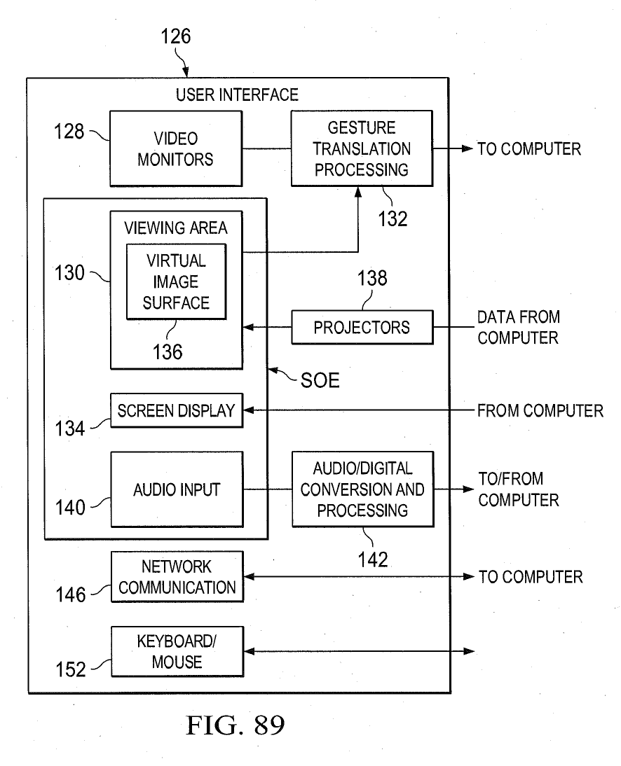

The preferred embodiments of a hyper-dimensional simulation system for reservoir engineering and geosciences are described in detail herein. As will be set forth, commands or requests to adjust, modify and supplement displays of the reservoir in evaluating subsurface reservoirs of interest may be made by users as illustrated in FIGS. 1A through 86C, inclusive. The commands or requests are received by a data processing system D (FIGS. 88 and 89) under control of a set of operating instructions according to a flow chart F (FIG. 87). The data processing system D provides displays in response to the requests or commands permitting users and others to evaluate present or possible production and performance by the reservoir according to a number of plans or scenarios at times of interest during the reservoir life. As will be set forth, the requests may be in the form of voice commands or hand poses or gestures.

According to the present invention, the term hyper-dimensional is defined as representing information in a spatial operating environment (SOE) illustrated schematically in FIG. 89 beyond the traditional three dimensions of space in the reservoir. The information on a vertical screen 134 (FIG. 89) is the traditional 3-D physical space representation (X, Y and Z coordinate directions) in the earth. As will be described, virtual surface displays (VS) 136 are represented in the SOE are considered as additional dimensions. As it is not feasible to touch or point to this virtual surface, a background such as an ordinary table is used for receiving the virtual data display. As will be described, a projector that is above the table or surface, projects the relevant information on the table. The plane in the spatial volume where the data being displayed exists in the reservoir is facilitated by having a background (or virtual surface) such as an ordinary table for display 136. This plane in space is pre-calculated to match the height and orientation of the table surface.

With the present invention, there is no limit in availability to the hyper-dimensional surfaces (virtual image displays) other than practical limitations such as available physical work space considerations. The available spatial volume of a particular setup is the only limitation, and the space available can be expanded. With the present invention, the added dimensions are termed as hyper-dimensions. The class of activities that uses voice instructions adds another hyper-dimension, and concurrent collaboration and remote networking are also added dimensions.

In this detailed description, wherever the term ‘reservoir’ is referred to in the present invention it refers to a reservoir model and it also refers to geological and seismic models. Reservoir data as used in the present invention refers to data representing these types of models, data obtained or extracted from processing field measurements or recordings regarding such models, and modelling tools used in analysing and evaluating such models. Thus, reservoir data includes well test data obtained from well logs performed in the reservoir and from other well tests, core data, reservoir fluid characterization data and reservoir properties such as porosity, saturation, permeability, seismic data and geologic data. It should also be understood that other types of data obtained from other sources or measurements regarding the reservoir being displayed may be used as well.

The new methodology according to the present invention of performing reservoir engineering and geosciences activities in the current invention are described below in a number of categories or classes: Exploring the Reservoir; Well Related Activities; Reservoir Engineering and Geosciences; Multidisciplinary Activities; and Hyper-Dimensional Voice Instructions.

### Exploring the Reservoir Class of Activities

The category or class of activities according to the present invention relating to exploring a reservoir of interest is illustrated in FIGS. 1A through 9C and 14A through 25C. One of the types of activities for exploring the reservoir provided by the present invention permits the reservoir to be traversed, as illustrated in FIGS. 1A through 6C. Relative movement of the reservoir is controlled by a gesture or pose as illustrated from a user/analyst, who may be a reservoir engineer, geoscientist or field personnel, as will be described. The data processing D (FIGS. 88 and 89) senses the gesture or pose and a computer implemented process (FIG. 87) causes a screen display 134 (FIG. 89) of the data processing system D to display movement of the reservoir images. The relative movement may be a traversing along any of the three fundamental co-ordinate reservoir axes, as well as a panning, tilting and roll movement.

FIG. 1A illustrates a display image on display 134 of the reservoir in an initial or starting position before horizontal navigation or traversing movement is begun. The image in display 134 is representative, and it should be understood that other data images described below regarding display screen 134 may be moved according the reservoir exploring class of activities herein described. FIG. 1B illustrates a hand pose or gesture made by a user. The hand pose or gesture of FIG. 1B has the user's thumb, index finger and middle finger pointing along three mutually orthogonal axes as shown while the hand is moved along the longitudinal axis of the user's middle finger. The user's hand in making the gesture shown in FIG. 1B and in subsequent drawing figures is positioned in a viewing station 130 of the data processing system D for the pose or gesture to be sensed and transformed into computer operating instructions, as will be described. If desired, indicia or gloves may be worn on the user's hand for enhanced detection and recognition of the gestures or poses herein described.

The hand pose or gesture of FIG. 1B causes navigation or traversing movement by the data processing system D of the reservoir image of FIG. 1A in a lateral or horizontal X-plane from east to west. FIG. 1C illustrates the adjusted results of navigation of the reservoir image as moved from east to west in response to the user pose or gesture of FIG. 1B.

FIG. 2A illustrates a display image on display 134 of the reservoir in an initial or starting position before horizontal navigation or traversing movement is begun. FIG. 2B illustrates a hand pose or gesture made by a user. The hand pose or gesture of FIG. 2B has the user's thumb, index finger and middle finger pointing along three mutually orthogonal axes as shown while the hand is moved along the longitudinal axis of the user's index finger.

The hand pose or gesture of FIG. 2B causes navigation or traversing movement by the data processing system D of the reservoir image of FIG. 2A in a Y-plane from front to back in the horizontal plane. FIG. 2C illustrates the resultant reservoir image moved from front to back, with the reservoir image on the display having moved along the Y-axis with respect to the user, in response to the user pose or gesture of FIG. 2B.

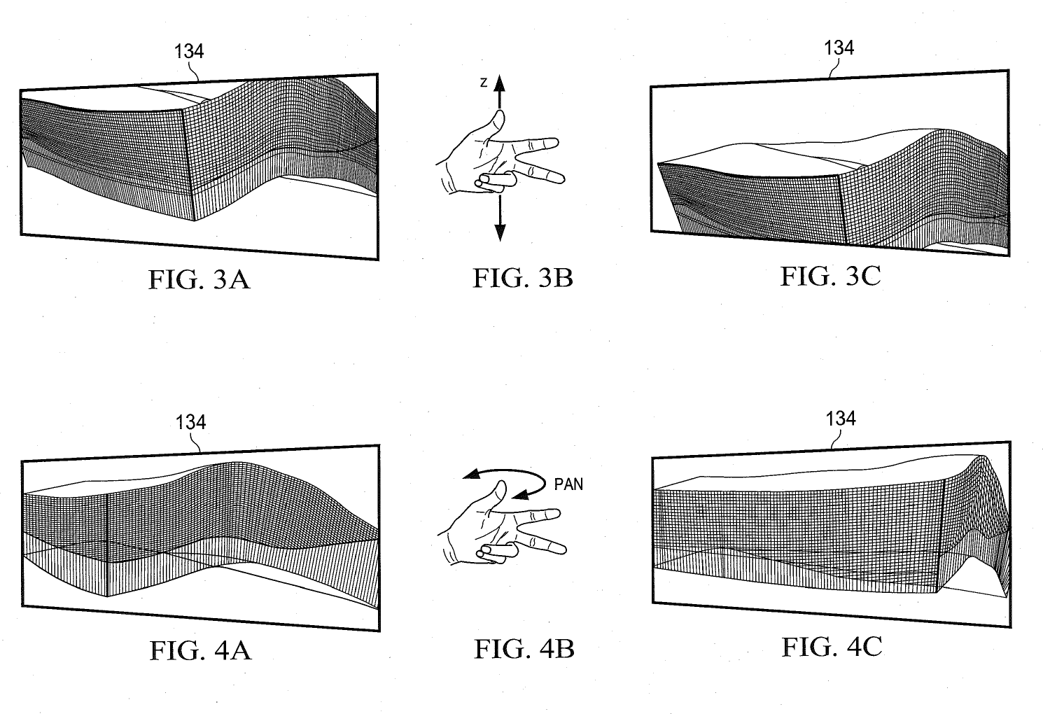

FIG. 3A illustrates a display image on display 134 of the reservoir in an initial or starting position before horizontal navigation or traversing movement is begun. FIG. 3B illustrates a hand pose or gesture made by a user. The hand pose or gesture of FIG. 3B has the user's thumb, index finger and middle finger pointing along three mutually orthogonal axes as shown while the hand is moved vertically along the longitudinal axis of the user's thumb.

The hand pose or gesture of FIG. 3B causes navigation or traversing movement by the data processing system D of the reservoir image of FIG. 3A in a vertical plane from south to north. FIG. 3C illustrates the resultant reservoir image moved in a vertical plane on the display 134 in response to the user pose or gesture of FIG. 3B.

As illustrated in FIGS. 1A through 3C, a new direct and more natural and efficient method of traversing the X, Y and Z coordinate directions of the reservoir through human hand poses and movement is provided by the present invention. It has been found that traversal movements for viewing and analysis of reservoir data made possible with the present invention in response to hand gestures or poses enhances the ability of users to analyze, model and simulate reservoir conditions and data. This ability and responsiveness is significant when compared to the indirect and specialized (mapping of mouse coordinates to screen coordinates) prior art way of accomplishing the traversals via a mouse and/or a keyboard.

FIG. 4A illustrates a display image on display 134 of the reservoir in an initial or starting position before panning or rotational movement is begun. FIG. 4B illustrates a hand pose or gesture made by a user. The hand pose or gesture of FIG. 4B has the user's thumb, index finger and middle finger pointing along three mutually orthogonal axes as shown while the hand is rotated in a clockwise direction in the horizontal plane about the longitudinal axis of the user's thumb.

The hand pose or gesture of FIG. 4B causes panning or rotational movement of the reservoir image of FIG. 4A in a horizontal plane around a vertical axis by the data processing system D. FIG. 4C illustrates the resultant reservoir image moved rotationally around a vertical axis in response to the user pose or gesture of FIG. 4B.

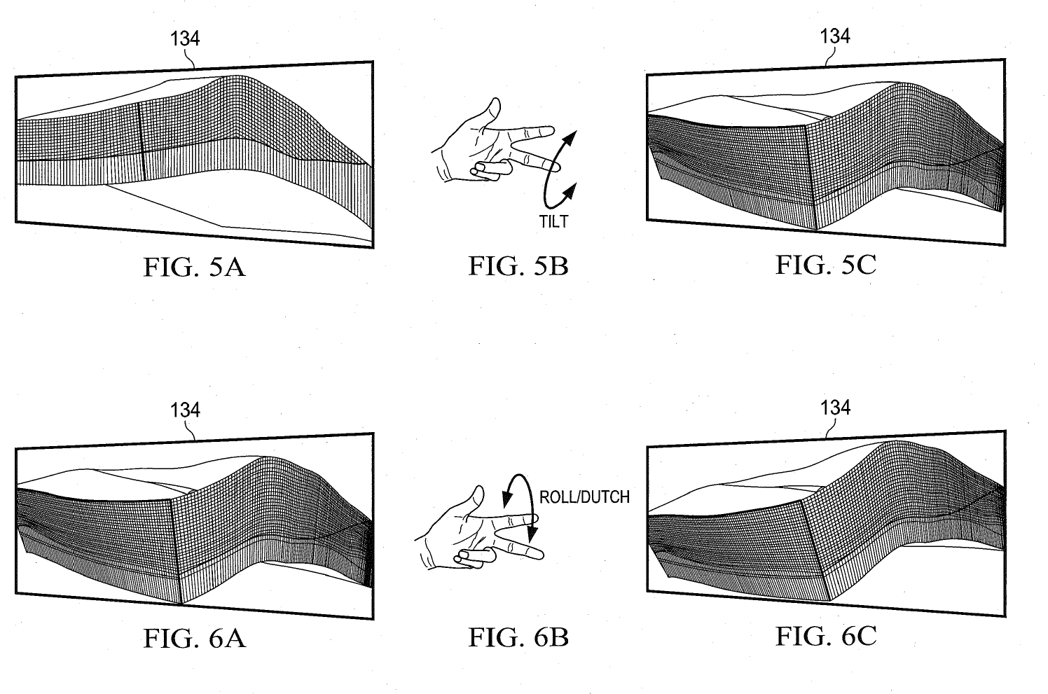

FIG. 5A illustrates a display image on display 134 of the reservoir in an initial or starting position before rotational movement of the image is begun. FIG. 5B which illustrates a hand pose or gesture made by a user. The hand pose or gesture of FIG. 5B has the user's thumb, index finger and middle finger pointing along three mutually orthogonal axes as shown while the hand is rotated in a vertical plane about the longitudinal axis of the user's middle finger.

The hand pose or gesture of FIG. 5B causes tilting movement of the reservoir image of FIG. 5A in a horizontal plane around an X-direction axis by the data processing system D. FIG. 5C illustrates the resultant reservoir image in the adjusted, tilted position available for evaluation and analysis of a previously hidden area of portion of the reservoir in response to the user pose or gesture of FIG. 5B.

FIG. 6A illustrates a display image on display 134 of the reservoir in an initial or starting position before tilting movement is begun. FIG. 6B illustrates a hand pose or gesture made by a user to cause tilting movement. The hand pose or gesture of FIG. 6B has the user's thumb, index finger and middle finger pointing along three mutually orthogonal axes as shown while the hand is rotated in a vertical plane about the longitudinal axis of the user's index finger.

The hand pose or gesture of FIG. 6B causes rolling or rotational movement of the reservoir image of FIG. 6A in a horizontal plane around a Y-direction axis by the data processing system D. FIG. 6C illustrates the resultant reservoir image in the adjusted, rotated position in response to the user pose or gesture of FIG. 6B.

As illustrated in FIGS. 4A through 6C, the present invention provides for panning, tilting and producing the rolling (slight feeling of imbalance as one fathoms the depths of an object on the screen to gain a better understanding) effects of an image of the reservoir through human hand poses and movement. Again, with the present invention, it has been found that providing movement of images of reservoir data through such hand gestures or poses of the reservoir enhances the ability of users to analyze, model and simulate reservoir conditions and data. More time is made for evaluation of the data rather than being spent in attempting to control and direct movement of the image displays by way of a series of key strokes on a keyboard, or mouse movements and click inputs.

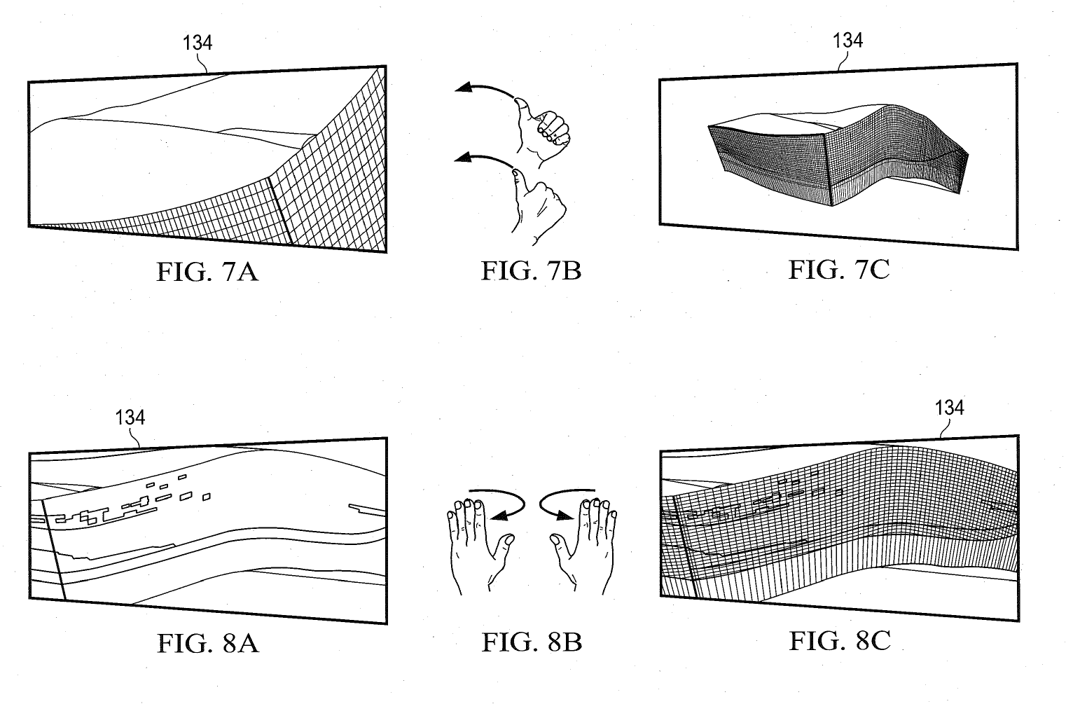

FIG. 7A illustrates an example reservoir image that appears on display screen 134 when the reservoir data is presented in the image after the position has been moved or traversed in the manner described above. FIG. 7B illustrates a hand pose or gesture made by a user to cause restoration of such reservoir image of FIG. 7A to an original state. The hand pose or gesture of FIG. 7B has the user's fingers on both hands folded inwardly toward the palms of the hands, with thumbs extended as shown, and the hands moved as indicated by motion arrows, as shown. The pose or gesture of FIG. 7B by a user causes restoration or reversion of the reservoir image from the adjusted state shown in FIG. 7A an initial or original state. FIG. 7C illustrates the reservoir image restored to its initial state in response to the user pose or gesture of FIG. 7B.

FIG. 8A illustrates a reservoir image in an original display state on display 134. FIG. 8B illustrates a hand pose or gesture by a user to cause application or placement of a simulation grid on the reservoir image of FIG. 8A. The hand pose or gesture of FIG. 8B has the user's hands extending upwardly, palms out, with fingers extended and the hands rotated inwardly in a vertical plane as shown. The pose or gesture of FIG. 8B by a user causes the placement or application by the data processing system D of a simulation grid on the display image shown in FIG. 8A. FIG. 8C illustrates the reservoir image of FIG. 8A with a simulation grid applied in response to the user pose or gesture of FIG. 8B.

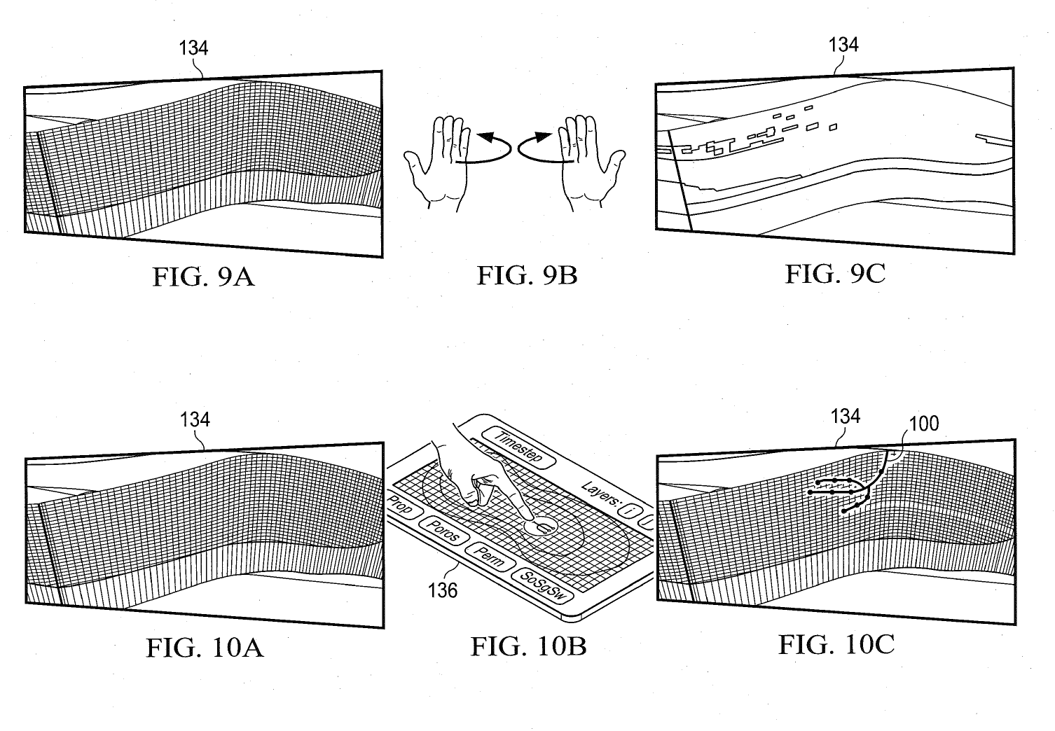

FIG. 9A illustrates a reservoir image with an applied simulation grid on computer controlled display 134. FIG. 9B illustrates a hand pose or gesture by a user to cause removal or deletion of the simulation grid from the reservoir image of FIG. 9A. The hand pose or gesture of FIG. 9B has the user's hands extending upwardly, palms inward, with fingers extended and the hands rotated outwardly in a vertical plane as shown. FIG. 9C illustrates the reservoir image of FIG. 9A with the simulation grid removed in response to the user pose or gesture of FIG. 9B.

Thus, in FIGS. 8A through 9C hand poses or gestures such as flipping of the palms of the hand, cause the display to show the reservoir grid (FIG. 8) and remove the reservoir grid (FIG. 9) from the display of reservoir data. These two simple and direct hand movements replace complicated and indirect prior art mouse presses and keyboard strokes.

FIG. 14A illustrates a geological layer or model in computer controlled display 134. FIG. 14B illustrates a hand pose or gesture by a user to cause vertical movement through the geological layer or model of FIG. 14A. The gesture of FIG. 14B has the user's hands extending outwardly, palms facing each other inwardly, with the hands moving as indicated by motion arrows. The pose or gesture of FIG. 14B by a user causes the movement by the data processing system D to a lower layer or model in the data being displayed than the display image shown in FIG. 14A. FIG. 14C illustrates the geological layer or model of FIG. 14A after vertical movement through it to a lower level in response to the user pose or gesture of FIG. 14B. Thus, a user may sweep vertically through a layer in the reservoir using a simple hand movement as illustrated in FIG. 14B.

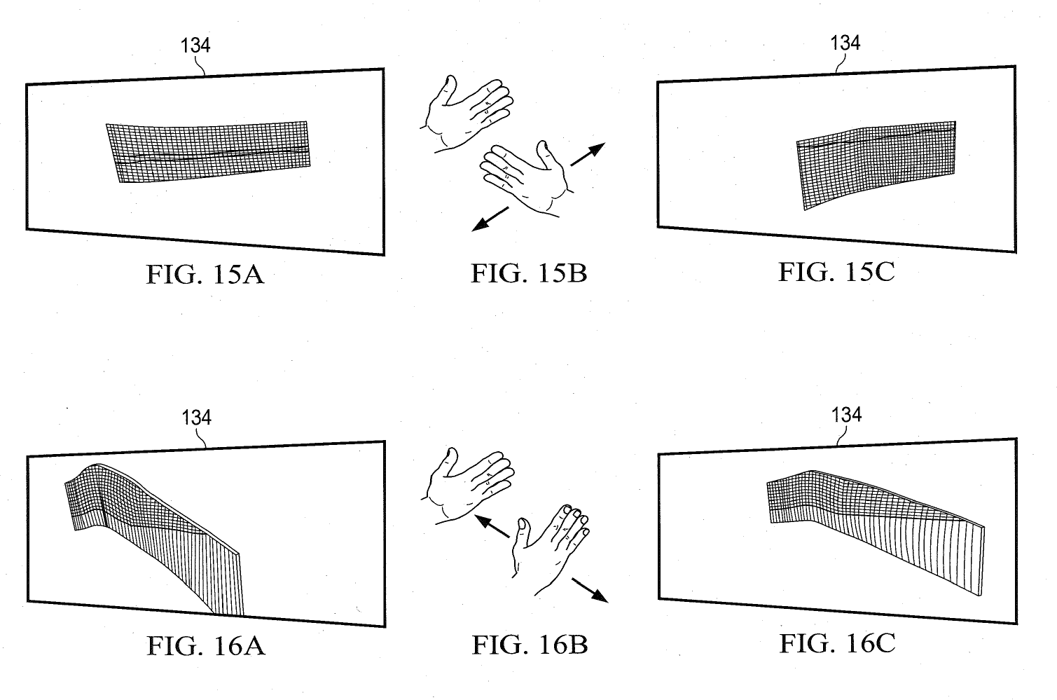

FIG. 15A illustrates a geological layer or model in computer controlled display 134. FIG. 15B illustrates a hand pose or gesture by a user to cause movement through X-direction cross-sections of the geological layer or model of FIG. 15A. The gesture of FIG. 15B has the user's hands extending laterally, palms facing inwardly, with the hands moving in the X-direction as indicated by motion arrows. The pose or gesture of FIG. 15B by a user causes the data processing system D to enable a user to move through the model/geologic X-direction cross-sections of the reservoir data from the display image shown in FIG. 15A. FIG. 15C illustrates the geological layer or model of FIG. 15A after movement through it in response to the user pose or gesture of FIG. 15B.

FIG. 16A illustrates a geological layer or model in computer controlled display 134. FIG. 16B illustrates a hand pose or gesture by a user to cause movement through Y-direction cross-sections of the geological layer or model of FIG. 16A. The gesture of FIG. 16B has the user's hands extending outwardly, palms facing inwardly, with the hands moving in the Y-direction as indicated by motion arrows. The pose or gesture of FIG. 16B by a user causes the data processing system D to enable a user to move through the model/geologic Y-direction cross-sections of the reservoir data from the display image shown in FIG. 16A. FIG. 16C illustrates the geological layer or model of FIG. 16A after movement through it in response to the user pose or gesture of FIG. 16B. Again, the present invention does not require a complicated sequence of computer keystrokes or mouse movements.

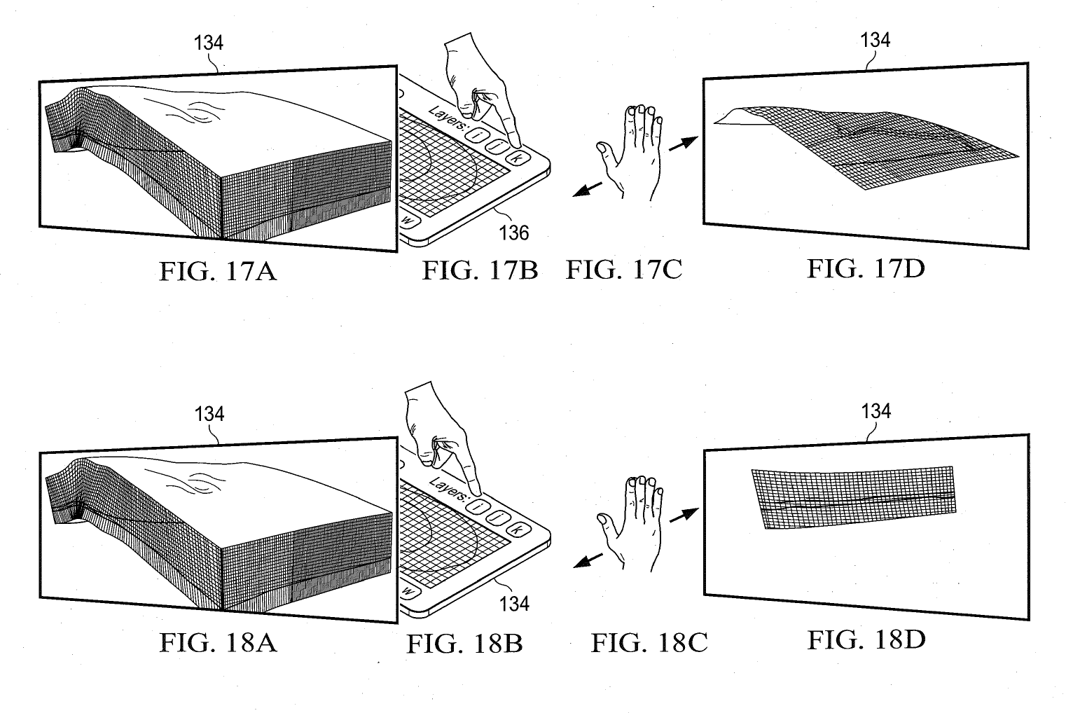

FIG. 17A illustrates a reservoir image on computer controlled display 134 in an initial state. FIG. 17B illustrates a user hand gesture taken with respect to a hyper-dimensional or virtual image surface display 136 of reservoir data. The virtual image surface display 136 is a physical surface located within the spatial operating environment (SOE) or viewing area 130 of the data processing system D (FIG. 89). The virtual display surface 136 is a background such as an ordinary table or other suitable surface. The virtual display surface illustrated in FIG. 17A represents a display of a model/geological layer of interest in the reservoir. FIG. 17B illustrates a user pose or gesture in the form of a hovering gesture of the user's hand over an area or segment of interest on the virtual display surface 136, in this instance a layer k of the reservoir to be selected for display. FIG. 17C illustrates a hand pose or gesture made by a user in the form of a hand extended upwardly, palm out as shown, and moving inwardly and outwardly as shown to indicate selection of the designated k-layer as illustrated by the hovering action shown in FIG. 17B. FIG. 17D illustrates a display of the geological layer or model selected in response to the user pose or gesture of FIG. 17C.

FIG. 18A illustrates a reservoir image on computer controlled display 134 like that of FIG. 17A. FIG. 18B illustrates a user hand gesture in the form of a hovering gesture of the user's hand taken with respect to the virtual surface image display 136 of reservoir data to designate an X-direction cross-section of the model/geological layer of interest in the reservoir shown in FIG. 18A. FIG. 18C illustrates a hand pose or gesture like that of FIG. 17C made by a user in the form of a hand extended upwardly, palm out as shown, and moving inwardly and outwardly as shown to indicate selection of the designated X-direction cross-section. FIG. 18D illustrates a display of the X-direction cross-section of the geological layer or model selected in response to the user pose or gesture of FIG. 18C.

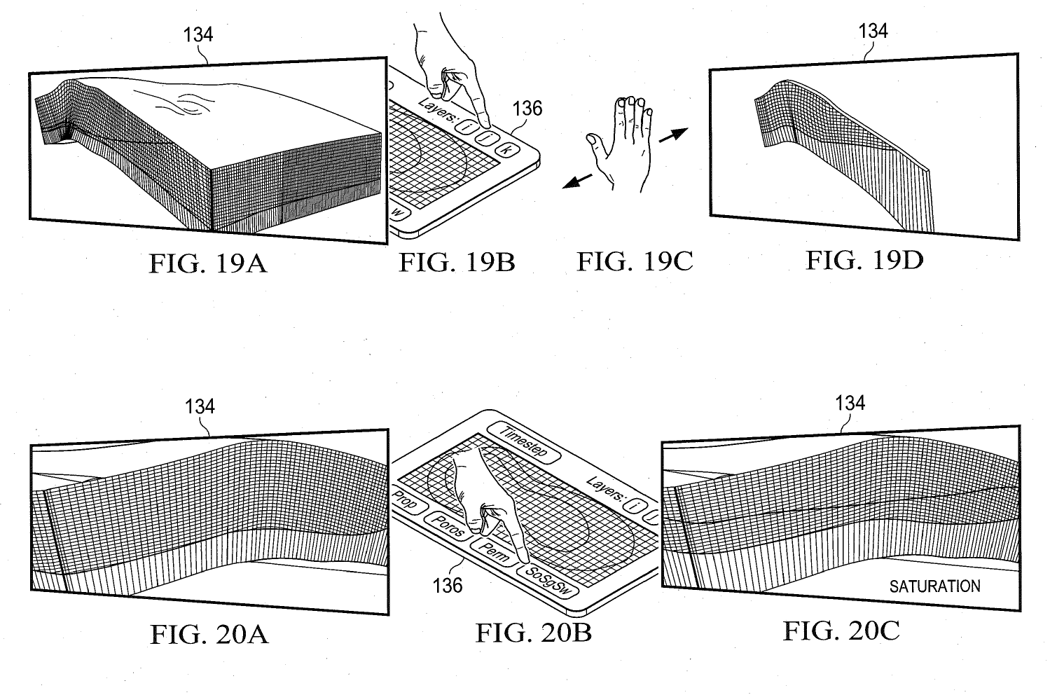

FIG. 19A illustrates again an initial reservoir image on computer controlled display 134. FIG. 19B illustrates a user hand gesture in the form of a hovering gesture of the user's hand taken with respect to the virtual surface image display 136 of reservoir data to designate a Y-direction cross-section of the model/geological layer of interest in the reservoir shown in FIG. 18A. FIG. 19C illustrates a user pose or gesture like that of FIGS. 17C and 18C taken to select display of the Y-direction cross-section of the model/geological layer in the reservoir designated by the hovering action shown in FIG. 19B. FIG. 19D illustrates a display of the Y-direction cross-section of the geological layer or model selected in response to the user pose or gesture of FIG. 19C.

FIG. 20A illustrates a reservoir image in an initial state on computer controlled display 134. FIG. 20B illustrates a user hand gesture in the form of a hovering gesture of the user's hand taken with respect to the virtual surface image display 136 of reservoir data to designate or select a measure or parameter of interest, in this instance ternary saturation (SoSgSw) of oil-gas-water, in the reservoir shown in FIG. 20A. FIG. 20C illustrates a computer controlled display 134 of the current state of the reservoir with respect to the selected ternary saturation measure or parameter of interest selected in response to the user pose or gesture of FIG. 20B. The saturation data may also be displayed as virtual image 136.

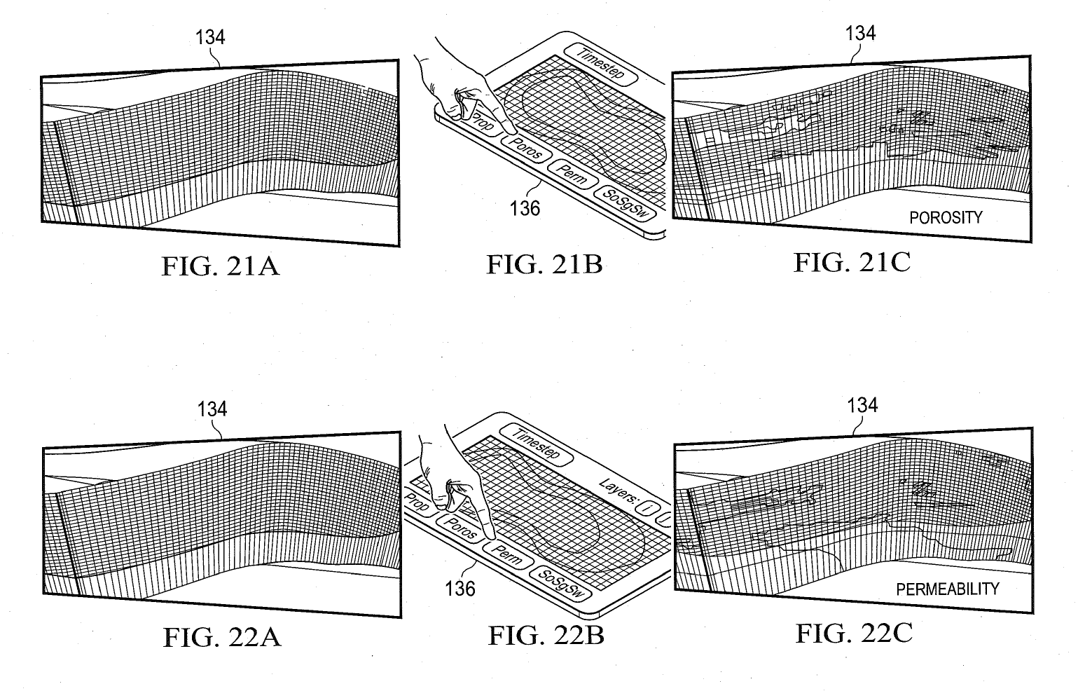

FIG. 21A like FIG. 20A illustrates an initial reservoir image on computer controlled display 134. FIG. 21B illustrates a user hand gesture in the form of a hovering gesture of the user's hand taken with respect to the virtual surface image display 136 of reservoir data to designate or select a measure or parameter of interest, in this instance formation porosity (Poros), in the reservoir shown in FIG. 21A. FIG. 21C is a schematic illustration of a computer controlled display 134 of the current state of the selected formation porosity parameter of interest selected in response to the user pose or gesture of FIG. 21B.

FIG. 22A also illustrates an initial reservoir image on computer controlled display 134. FIG. 22B illustrates a user hand gesture in the form of a hovering gesture of the user's hand taken with respect to the virtual surface image display 136 of reservoir data to designate or select a measure or parameter of interest, in this instance formation permeability (Perm), in the reservoir shown in FIG. 22A. FIG. 22C is a schematic illustration of a computer controlled display 134 of the current state of the selected formation permeability parameter of interest selected in response to the user pose or gesture of FIG. 21B.

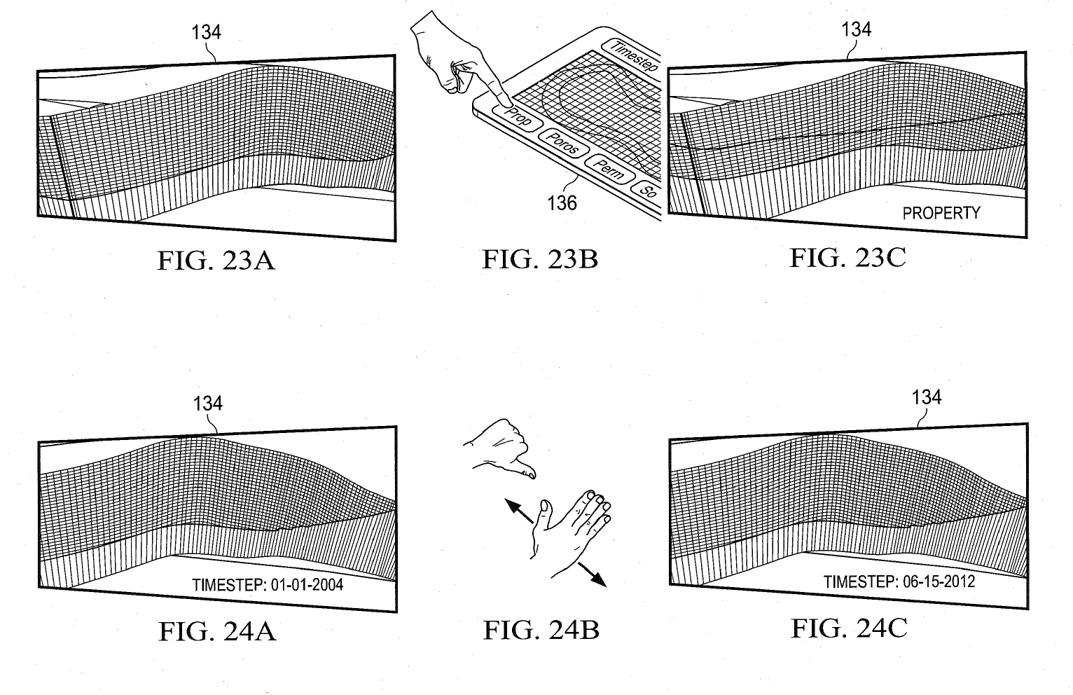

FIG. 23A also illustrates a reservoir image on a computer controlled display. FIG. 23B illustrates a user hand gesture in the form of a hovering gesture of the user's hand taken with respect to the virtual surface image display 136 of reservoir data to designate or select to select another measure or parameter of interest in the reservoir shown in FIG. 23A. The reservoir parameter of interest may be any of other reservoir properties or parameters of interest in addition to saturation, porosity and permeability previously described, or some other arbitrarily selected reservoir property of interest in addition to those of FIGS. 20 through 22 for presentation in a display to examine the current state of the reservoir with respect to that property. FIG. 23C is a schematic illustration of a computer controlled display of the measure or parameter of interest selected in response to the user pose or gesture of FIG. 23B.

The reservoir activities described above and illustrated in FIGS. 20A through 23C introduce the hyper-dimension of a virtual surface 136 combined with the vertical screen display 134. The virtual display surface 136 is a surface in space in the spatial operating environment (SOE) previously described. In these reservoir activities, it can be seen that a simple and direct hovering at or over a virtual surface causes displays of the selected property (ternary saturation of gas-oil-water, porosity, permeability or an arbitrary property) which with conventional reservoir simulation displays has required a complicated combination of mouse clicks or presses and keyboard strokes.

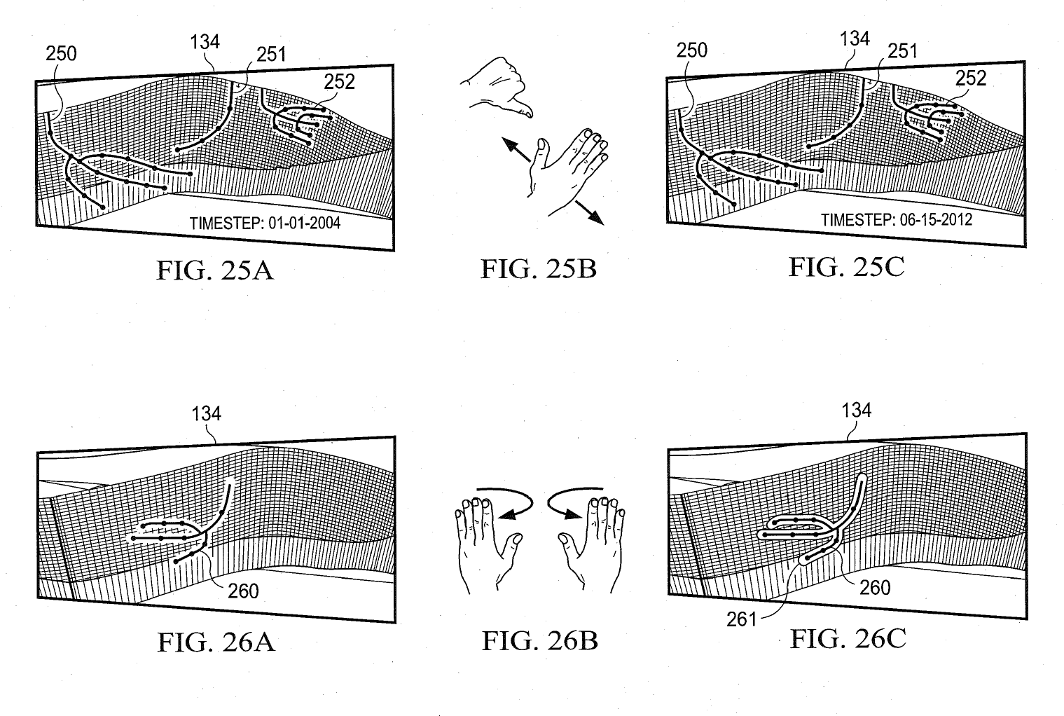

With the present invention, reservoir activities of observing the sweep of the hydrocarbon fluids as a result of production and injection over a period of time (and at a particular time in reservoir history) is accomplished through simple hand movements, as illustrated in FIGS. 24A through 25C.

FIG. 24A illustrates computer controlled display 134 indicating reservoir data to indicate fluid data such as type, presence, state and movement in an area of interest at an initial time for a reservoir at a particular initial time of interest. FIG. 24B illustrates a pose or gesture by a user to cause movement to a new time of interest of the area of the reservoir illustrated in FIG. 24A. The hand pose or gesture of FIG. 24B has the user's left hand closed with thumb extended as shown, and the right hand extended forward with palm facing in. The right hand moves laterally from side to side as indicated by movement arrows to move the reservoir data of interest to its state at a different point in time, as requested. FIG. 24C illustrates a computer controlled display of data for the reservoir of FIG. 24A at the new time of interest to permit observation of changes in the reservoir as a function of time as a result of production and injection.

FIG. 25A illustrates computer controlled display 134 of a reservoir at a particular initial time of interest having a number of wells 250, 251 and 252 located as indicated in the reservoir. FIG. 25B illustrates a pose or gesture by a user like that of FIG. 24B to cause movement to a selected new time of interest of the display of the reservoir illustrated in FIG. 25A. FIG. 25C illustrates a computer controlled display 134 of the reservoir of FIG. 24A at the new time of interest to permit observation of fluid data such as type, presence, state and movement in an area of interest of the reservoir at the new time of interest.

It should be understood that although the reservoir activities described in FIGS. 1A through 9C, FIGS. 14A through 19D and FIGS. 24A through 25C are illustrated on a vertical display screen in front, these activities can also be performed on other ‘hyper-dimensions’ such as on virtual surface 136 in the spatial volume of the type shown schematically in FIGS. 20B, 21B, 22B and 23B.

### Well Related Class of Activities

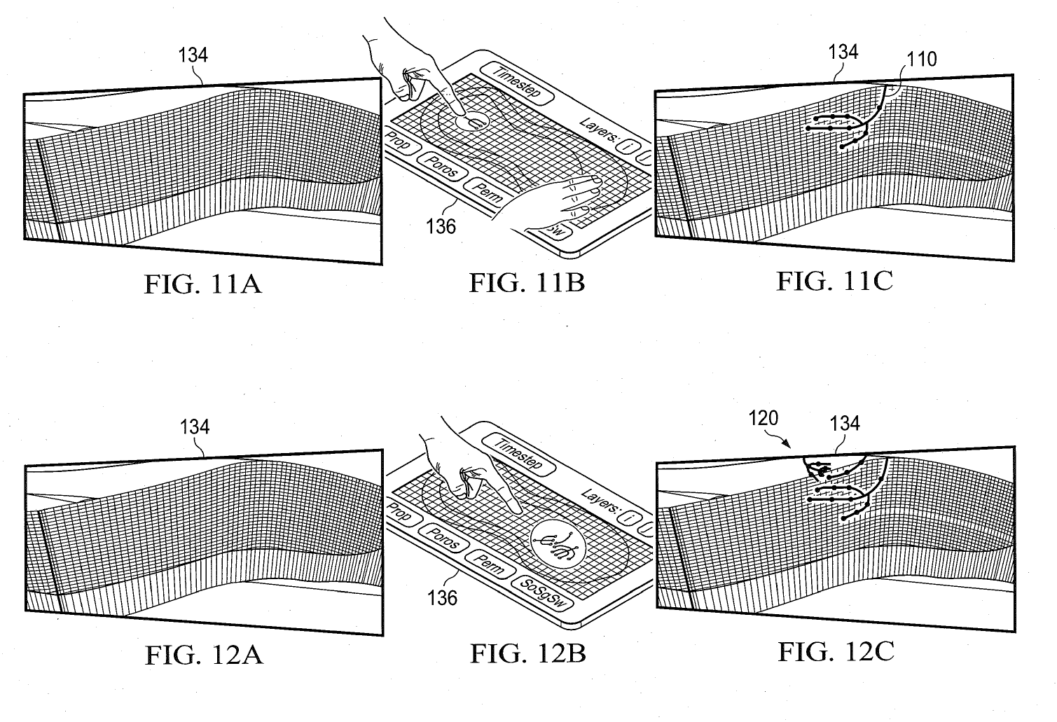

In this class of activities, which are shown in FIGS. 10 through 13 and 26 through 41, well design, well selection, well site tracking both on a single well or wells in a region using the methods of the present invention are performed, as will be described.

FIG. 10A illustrates a reservoir image in an initial state on computer controlled display 134. FIG. 10B illustrates a user hand gesture taken with respect to a hyper-dimensional or virtual image surface display 136 of reservoir data. FIG. 10B illustrates a user pose or gesture in the form of a hovering gesture of the user's hand over an area or segment of interest of the reservoir being displayed on the virtual display surface 136 to indicate an inquiry whether a well is present in the indicated area of the reservoir in virtual surface image 136. FIG. 10C illustrates an indication of wells 100 on display screen 134 as present in the reservoir data in response to the hovering and pointing action of FIG. 10B.

FIG. 11A like FIG. 10A shows a reservoir surface in an initial state before the locking in or focusing on a well of interest. FIG. 11B shows a two handed pose or gesture taken with respect to the virtual image display 136 that accomplishes the locking in or focusing action of the well of interest so that reservoir data in the vicinity of that well can be made available on the virtual display surface for analysis and evaluation. The gesture of FIG. 11B includes a hovering gesture of the user's left hand over an area or segment of interest and the user's right hand extended over the display palm facing down data to focus or lock in a selected well at the selected area or region. FIG. 11C illustrates a display of the well 110 of interest in the reservoir data, which can be made available on either as screen display 134 or virtual image display 136.

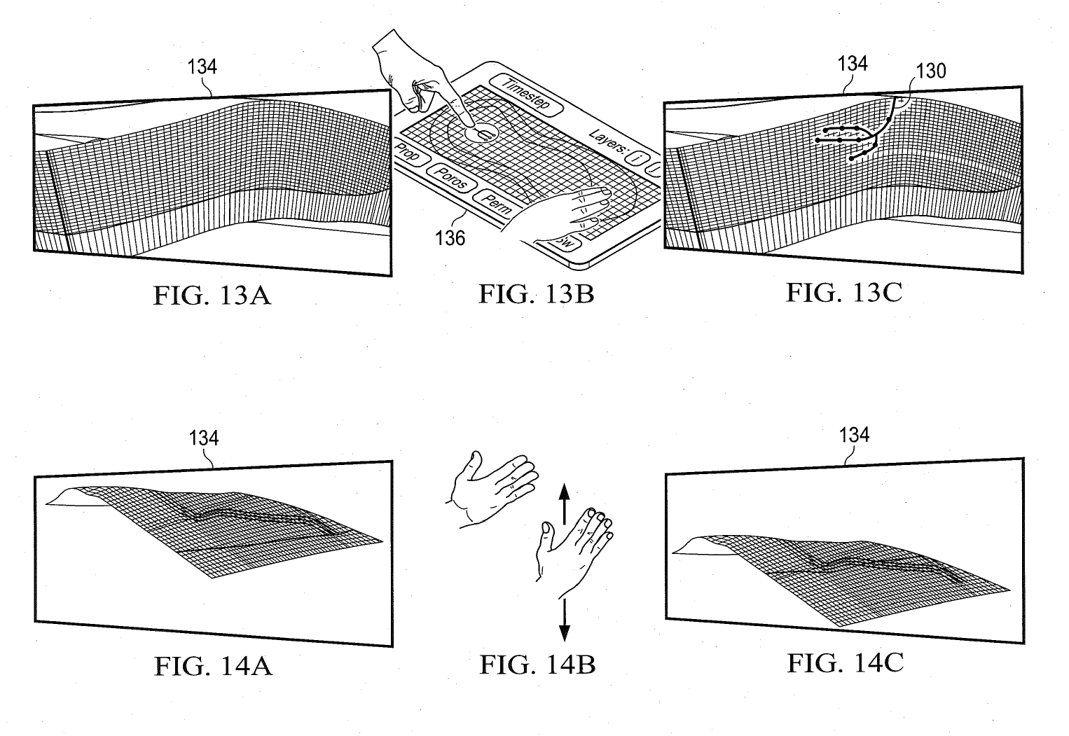

In FIGS. 12 and 13, the hovering and pointing gestures are over a region of interest virtual image display 136 to select a group of wells and lock in the selected wells. FIG. 12A again illustrates a reservoir image with an applied simulation grid on computer controlled display 134. FIG. 12B illustrates a user pose or gesture like that of FIG. 10B in the form of a hovering gesture of the user's hand over an area or segment of interest of the reservoir being displayed on the virtual display surface 136 to select several wells in a region. FIG. 12C illustrates a display in one or more of the displays 134 and 136 of several requested wells 120 in a reservoir image like that of FIG. 12A in response to the user gestures of FIG. 12B.

FIG. 13A like FIG. 12A illustrates a reservoir image with an applied simulation grid on computer controlled display 134. FIG. 13B illustrates a two hand gesture like that of FIG. 11B taken with respect to virtual surface image display 136 to focus or lock in a selected group of wells at a selected area or region in a virtual surface image of the reservoir shown in FIG. 13A. FIG. 13C illustrates the group of wells selected in response to the user gestures of FIG. 13B displayed in the reservoir image of FIG. 13A. The display requested by the gesture of FIG. 13B of selected wells of interest 130 in the reservoir data can, as has been set forth, be made available on either as screen display 134 or virtual image display 136.

FIG. 26A illustrates a well path 260 in a reservoir being displayed on screen display 134, much like a display of the well of interest in the reservoir data illustrated in FIG. 11C. FIG. 26B illustrates a hand pose or gesture by a user to cause highlighting or visual emphasis of the well path 208 in the display of FIG. 26A. The hand pose or gesture of FIG. 26B has the user's hands extending upwardly, palms out, with fingers extended and the hands rotated inwardly in a vertical plane as shown to indicate that the path of the well of interest shown in the first window is to be highlighted or visually emphasized. FIG. 26C illustrates a computer controlled display of the reservoir of FIG. 26A with the well path 260 by the border line or outline 261 visually emphasized. The highlighted well paths assume the current space and time value of the selected property. For example, if the selected property is the saturation of oil, gas and water (combination property), it becomes very easy for the reservoir engineer and/or geoscientist to visualize the composition of the fluid stream that is flowing into the wellbore at all points along the well.

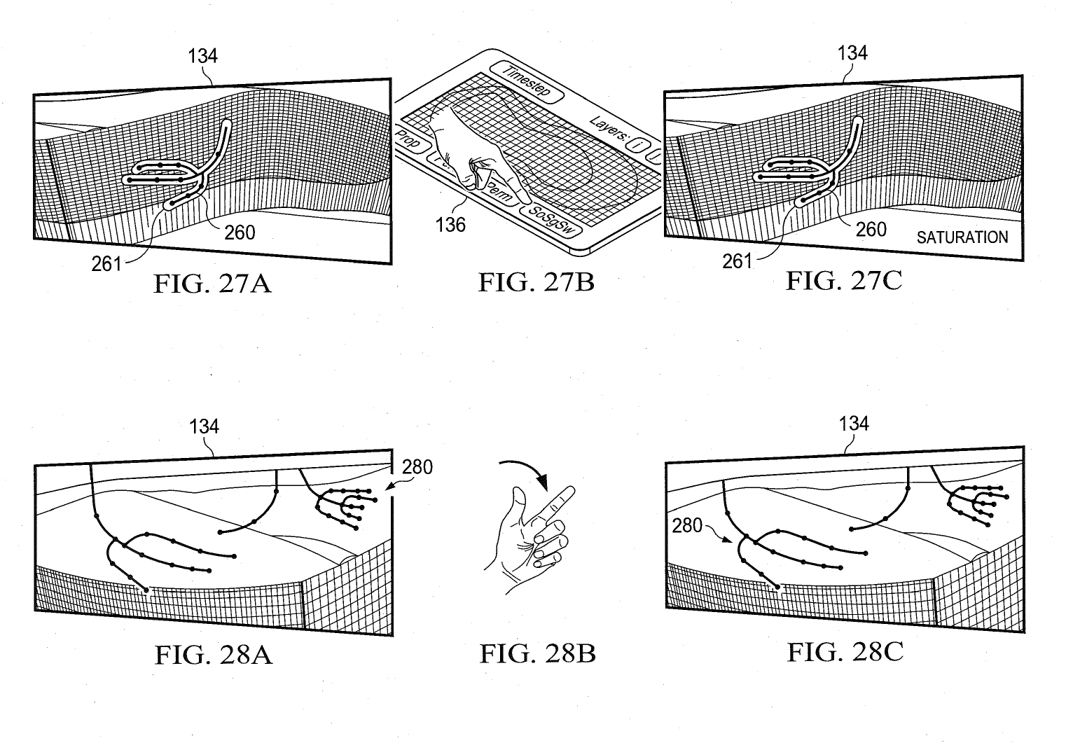

FIG. 27A illustrates a computer controlled display on screen 134 of a reservoir with a well path 270 visually emphasized like that of FIG. 26C. FIG. 27B illustrates a hovering gesture of the user's hand taken with respect to the virtual surface image display 136 of reservoir data to designate or select a measure or parameter of interest, in this instance ternary saturation of oil-gas-water (SoSgSw) of oil-gas-water, in the reservoir shown in FIG. 27A. FIG. 27C illustrates a computer controlled display 134 of the current state of the reservoir in the region of well path 270 with respect to the selected ternary saturation measure or parameter of interest selected in response to the user pose or gesture of FIG. 27B of designated measure or parameter of along the well path of FIG. 27A.

Thus, the present invention permits highlighting of a well path to examine the fluids that enter the wellbore from the reservoir (a producing well) and the reverse of the process (an injection well) is accomplished by using a flipping of the palms of the hand and switching of the gesture, as illustrated in FIG. 26B.

FIG. 28A like FIG. 26A illustrates computer controlled display screen 134 indicating a reservoir with a group of wells 280 as currently located. FIG. 28B illustrates a hand pose or gesture by a user with the hand extend outward, thumb up, index finger pointing outward and remaining fingers folded and a rotational movement as indicated by movement arrows to cause picking of a selected group of wells 280 in the display of FIG. 28A. FIG. 28C illustrates a computer controlled display on screen 134 of the selected group of wells 280 in the display of FIG. 28A.

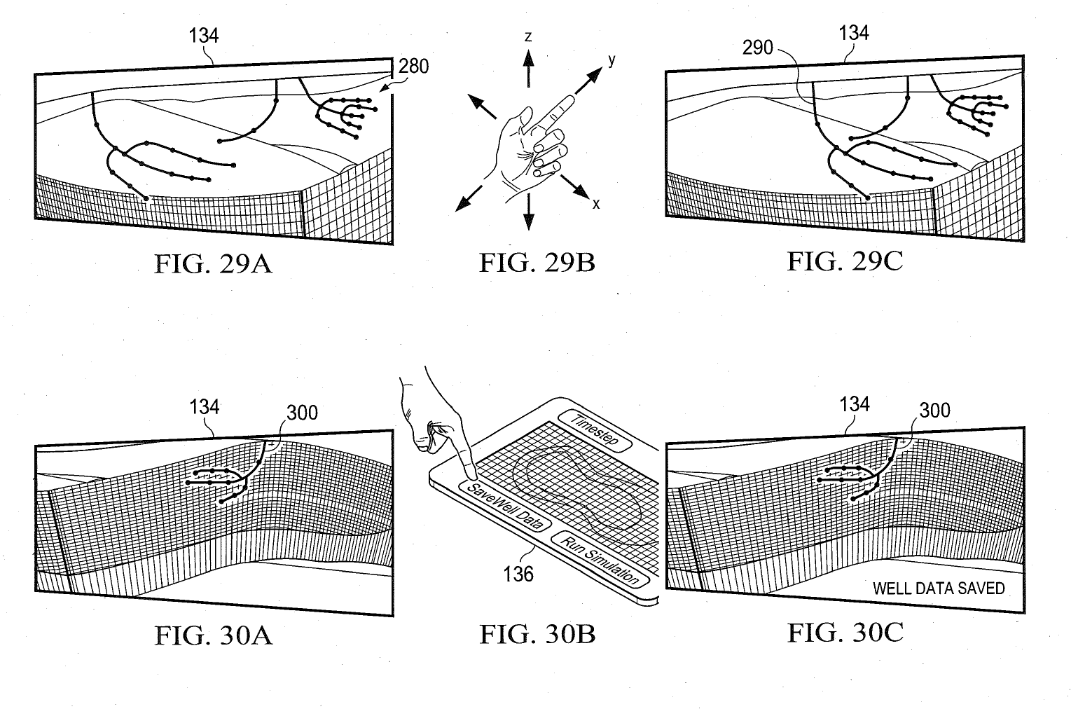

FIG. 29A illustrates a computer controlled display 134 of the selected group of wells 280 from FIG. 28C in a reservoir at their current locations. FIG. 29B illustrates a pose or gesture by a user with the hand extend outward, thumb and index finger pointing outward and remaining fingers folded and longitudinal movement along one of three orthogonal axes as indicated by movement arrows to cause picking and moving a well from the selected group to a different proposed location in the simulation model of the reservoir in the display of FIG. 29A. FIG. 29C illustrates a computer controlled display of the selected well 290 in the display of FIG. 29A moved to a new location.

FIG. 30A illustrates a computer controlled display 134 of a well path 300 in a reservoir being displayed on screen display 134 after having been moved to a new location, such as by the procedure shown in FIG. 29B. FIG. 30B illustrates a hovering hand gesture taken with respect to a designated area of virtual surface image display 136 to write or save in computer memory and cause storage in computer memory of the new location of the well 300 in the display of FIG. 30A. FIG. 30C illustrates a computer controlled display action on screen 134 or 136 to confirm that the new location of the re-located well has been stored in a memory file.

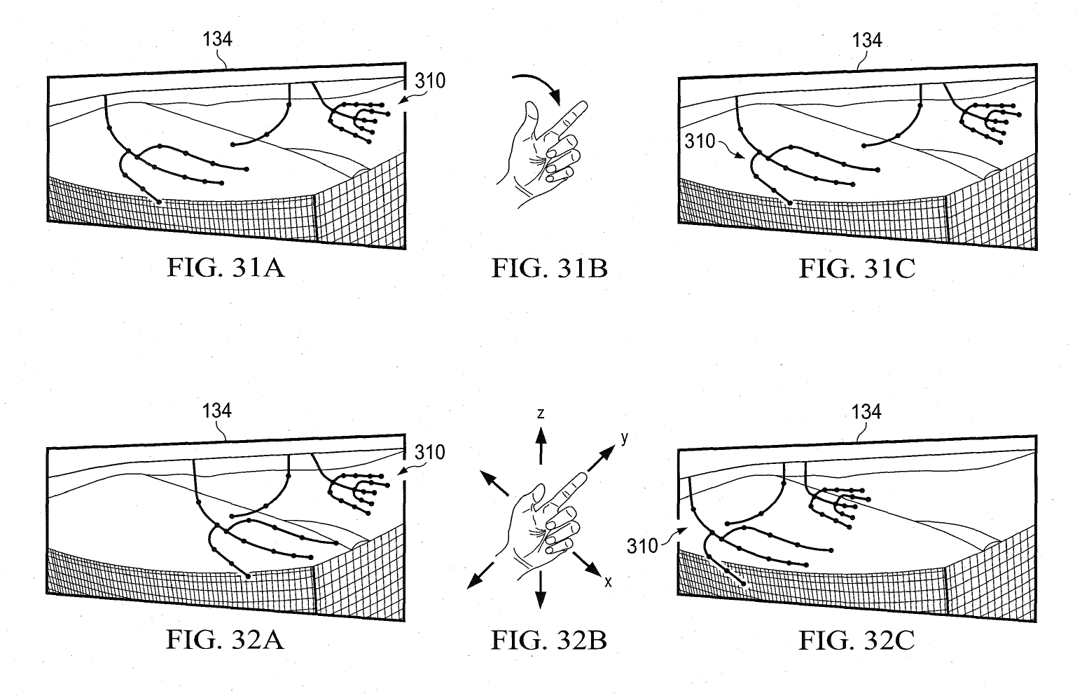

FIG. 31A like FIG. 28A illustrates a computer controlled display of a selected group of wells 310 at their current location in a reservoir. FIG. 31B illustrates a pose or gesture by a user like that if FIG. 28B to cause picking of the group of wells 310 in a region of the display of FIG. 31A. FIG. 31C illustrates a computer controlled display of the selected wells 310 of FIG. 31A.

FIG. 32A illustrates a computer controlled display 134 of the selected group of wells 310 from FIG. 31C in a reservoir at their current locations. FIG. 32B illustrates a pose or gesture by a user like that of FIG. 29B to cause picking and moving a well from the selected group to a different proposed location in the simulation model of the reservoir in the display of FIG. 32A. FIG. 32C illustrates a computer controlled display of the selected wells 310 of FIG. 32A moved to a new location.

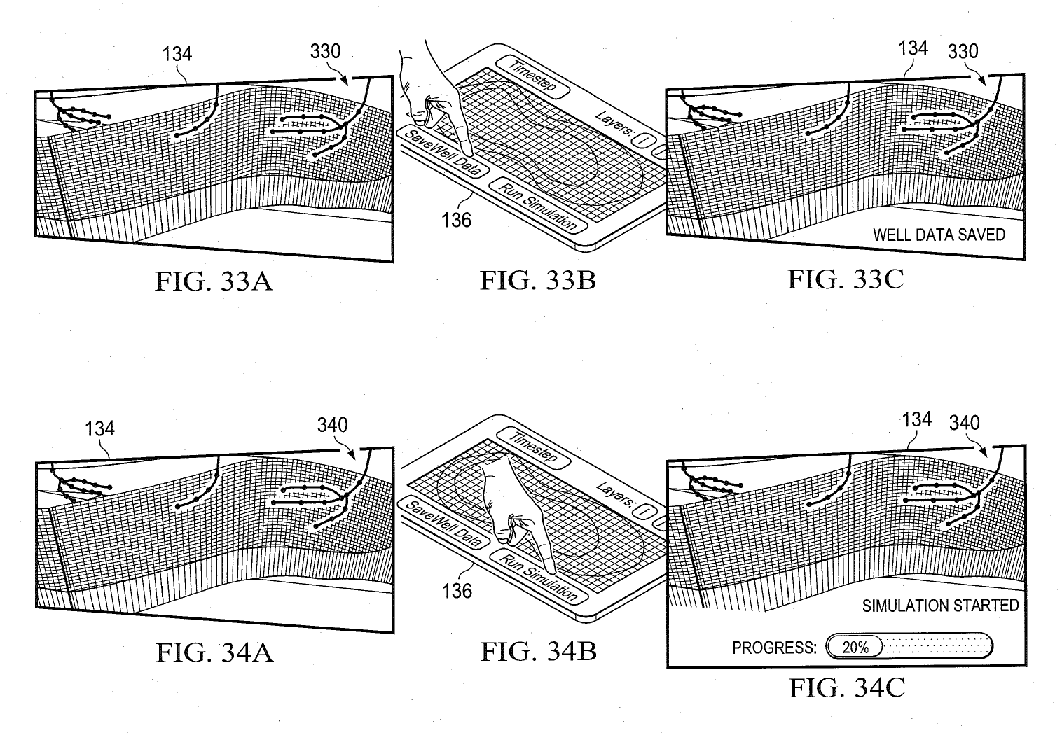

FIG. 33A like FIG. 30A illustrates a computer controlled display 134 of a the group of well paths 330 in a reservoir being displayed on screen display 134 after having been moved to a new location, such as by the procedure shown in FIG. 32B. FIG. 33B illustrates a hovering hand gesture taken with respect to a designated area of virtual surface image display 136 to write or save in computer memory and cause storage in computer memory of the new location of the well 330 in the display of FIG. 30A. FIG. 33C illustrates a computer controlled display action on screen 134 or 136 to confirm that the new location of the re-located well has been stored in a memory file.

FIG. 34A illustrates a computer controlled display 134 of a selected group of wells 340 in a reservoir. FIG. 34B illustrates a hovering hand gesture taken with respect to a designated area of virtual surface image display 136 to cause a reservoir simulation to be performed. FIG. 34C illustrates a computer controlled display to confirm that the simulation has begun and is running.

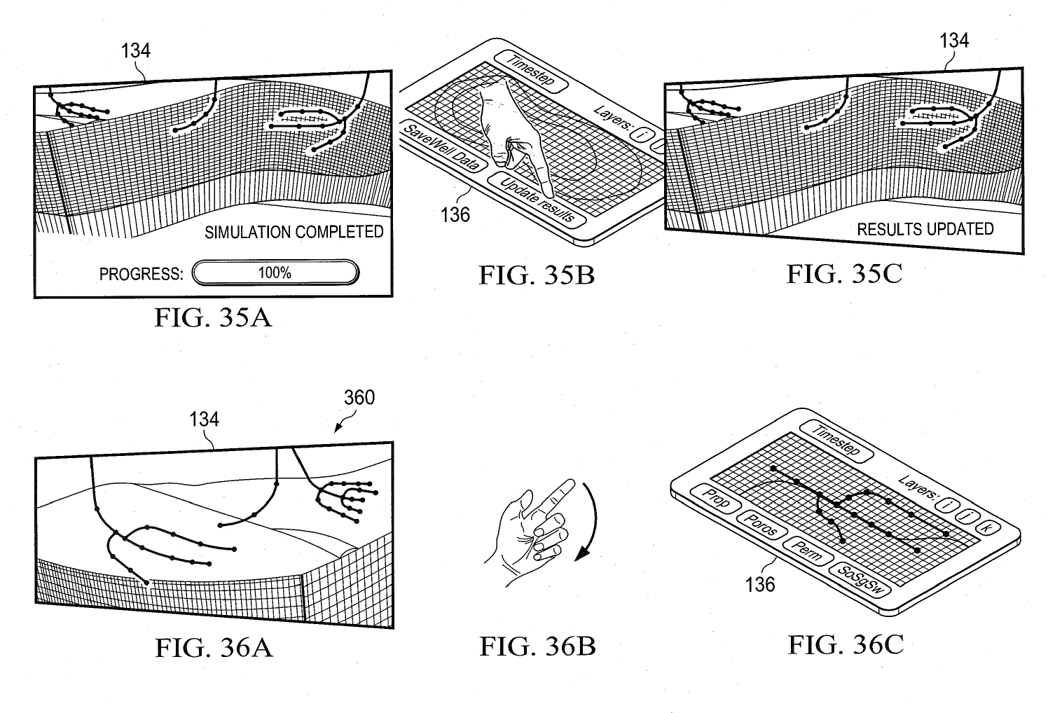

FIG. 35A illustrates a computer controlled display to confirm that the simulation requested as shown in FIG. 34B has been completed. FIG. 35B illustrates a hovering hand gesture taken with respect to a designated area of virtual surface image display 136 to write or save in computer memory and cause storage in computer memory of the results of the simulation after completion has been indicated according to FIG. 35A. FIG. 35C illustrates a computer controlled display action on screen 134 or 136 to confirm that the new location of the re-located well results of the simulation have been stored in a memory file.

The present invention thus provides the ability to pick or select a well (or several wells in a region of the reservoir) and re-tracking the well or wells. This can be simulated as an aid to improve oil and gas recovery while reducing water production and realizing the impact of these reservoir engineering activities. This capability provided by the present invention is accomplished through gestures as illustrated in FIGS. 28A through 35C.

FIG. 36A illustrates computer controlled display screen 134 indicating a reservoir with a selected group of wells 360 as currently located. FIG. 36B illustrates a hand pose or gesture by a user with the hand extend outward, thumb and index finger pointing outward and remaining fingers folded and a rotational movement as indicated by movement arrows to cause illustrates a hand gesture made to cause fetching of the well data in the vertical screen display 134 of FIG. 36A for transfer of the picked well data to the virtual surface image display 136. FIG. 36C illustrates the requested well data on the hyper-dimensional surface 136.

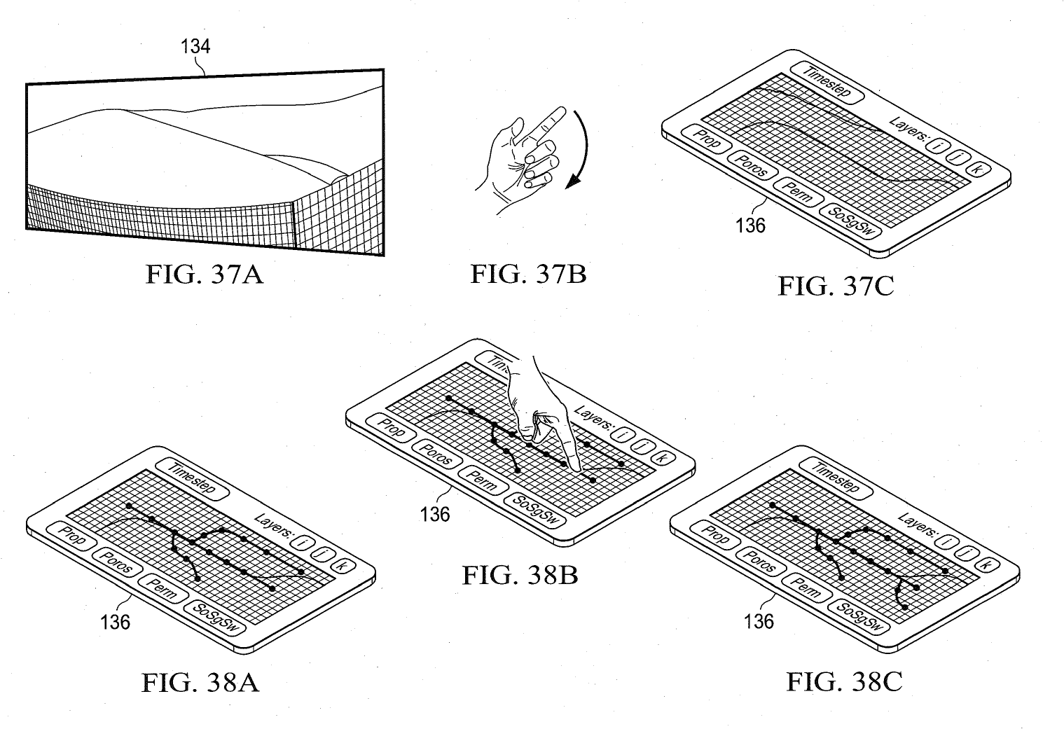

FIG. 37A illustrates computer controlled display screen 134 indicating reservoir data 370 of a region of interest. FIG. 37B illustrates a hand pose or gesture like that of FIG. 36B by a user with the hand extend outward, thumb and index finger pointing outward and remaining fingers folded and a rotational movement as indicated by movement arrows to cause picking or fetching of the reservoir data of the display of FIG. 37A for transfer of the picked reservoir data to the virtual surface image display 136. FIG. 37C illustrates a display on the hyper-dimensional surface 136 of the picked reservoir data selected in the manner shown in FIG. 37B.

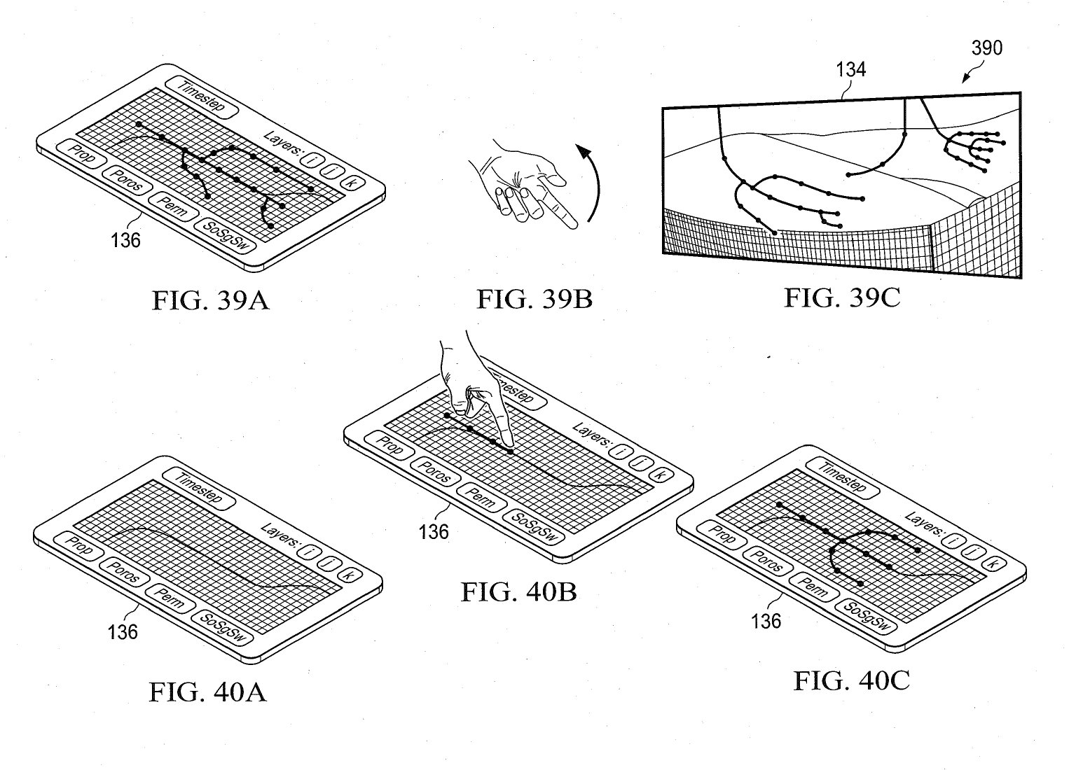

FIG. 38A illustrates a virtual surface image display 380 of reservoir data on a hyper-dimensional surface 136 in its current well configuration. FIG. 38B illustrates the re-designing process performed by hovering action towards the surface 136 displaying the well data in the display of FIG. 38A. FIG. 38C illustrates a virtual surface image display on the hyper-dimensional surface 136 of the redesigned wells.

FIG. 39A illustrates a virtual surface image display 136 of redesigned wells 380 like those of FIG. 38C. FIG. 39B illustrates a hand pose or gesture by a user with the hand extend outward, thumb and index finger pointing outward and remaining fingers folded and a rotational movement as indicated by movement arrows to cause illustrates a hand gesture made to cause the well data in the display of FIG. 39A to be transferred into a computer memory file of reservoir data. FIG. 39C illustrates a computer controlled display screen 134 of the stored data for redesigned group of wells 390 in the parent reservoir data.

FIG. 40A illustrates a virtual surface image display 136 of a selected region on a surface in reservoir data. FIG. 40B illustrates a hovering hand gesture taken with respect to a designated area of virtual surface image display 136 as one of several gestures of design of a well to be performed. FIG. 40C illustrates a virtual surface image display on a hyper-dimensional surface 136 of a well newly designed in the manner shown in FIG. 40B.

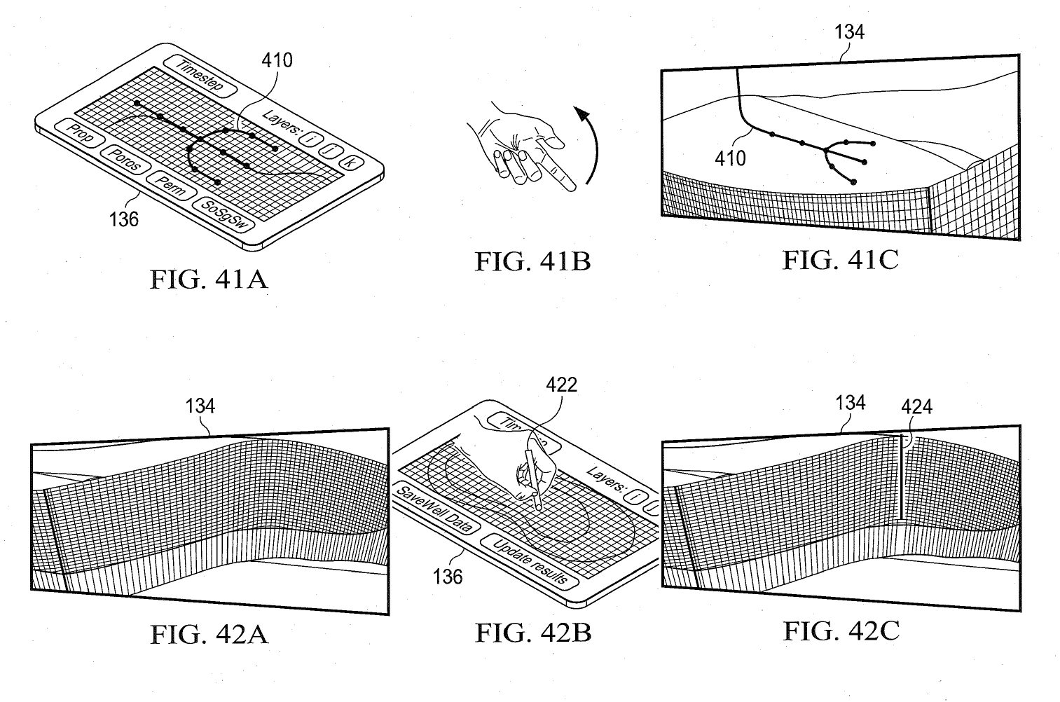

FIG. 41A illustrates a virtual surface image display 136 of redesigned wells 410 like those of FIG. 40C. FIG. 41B illustrates a hand pose or gesture by a user with the hand extend outward, thumb and index finger pointing outward and remaining fingers folded and a rotational movement as indicated by movement arrows to cause illustrates a hand gesture made to cause a grabbing or retrieval action of the well data in the display of FIG. 41A for return to be transferred into a computer memory file (FIG. 88) of reservoir data. FIG. 41C illustrates a computer controlled display screen 134 of the stored data for redesigned group of wells 410 in the parent reservoir data.

Thus, the present invention provides reservoir engineering activities of precisely designing new wells (and/or re-designing existing wells) by fetching the well (or wells) from the reservoir onto hyper-dimensional surface 136, performing the design on surface 136 and returning the designs (or re-designs) back to the reservoir using hand gestures and hovering actions shown in FIGS. 36A through 41C.

### Reservoir Engineering and Geosciences Class of Activities that Use Physical Objects

The use of physical objects which symbolize wells or other subsurface objects or features of interest in connection with reservoir engineering and geosciences class of activities is illustrated in FIGS. 42A through 45C. FIG. 42A illustrates computer controlled display screen 134 or hyper-dimensional surface 136 indicating reservoir data 420 of a region of interest. FIG. 42B illustrates placement of a physical object 422 on hyper-dimensional surface 136. The physical object 422 is symbolically recognizable by the data processing system D as representative of a physical vertical well to be located in the reservoir at the location indicated with respect to surface 136. FIG. 42C illustrates a display on the display screen 134 of indicating placement of a well 424 as indicated by the location of the object 422 on the of display hyper-dimensional image surface 136.

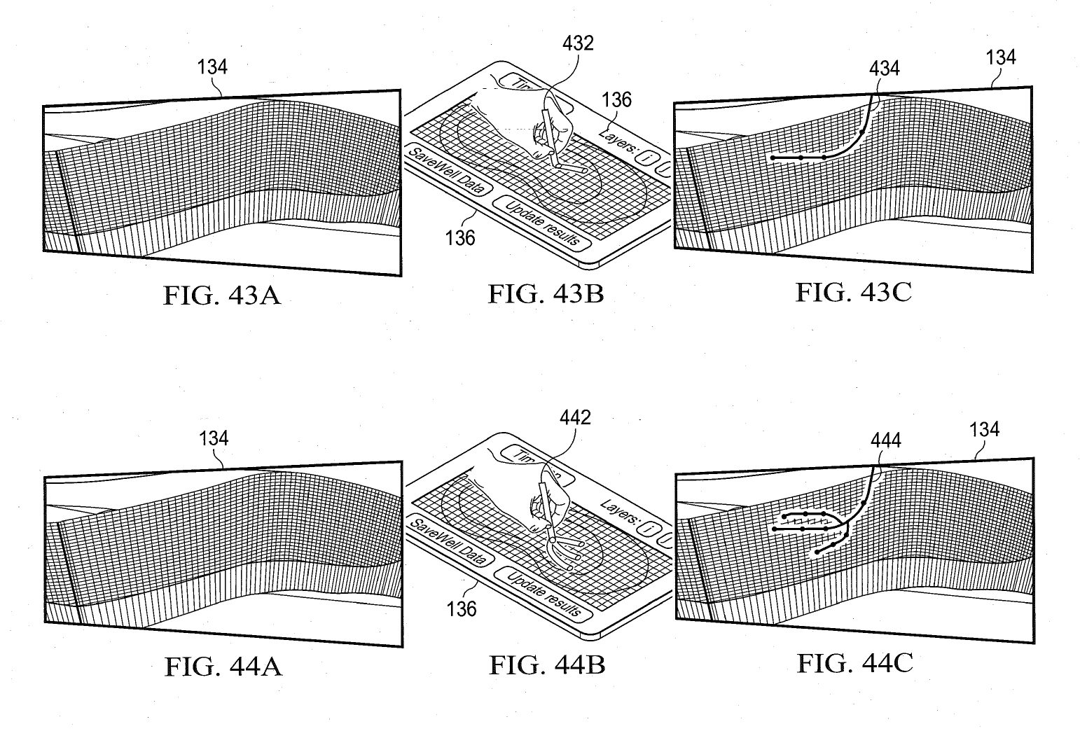

FIG. 43A illustrates computer controlled display screen 134 or hyper-dimensional surface 136 indicating reservoir data 430 of a region of interest like that of FIG. 42A. FIG. 42B illustrates placement of a physical object 432 on hyper-dimensional surface 136. The physical object 432 is symbolically recognizable by the data processing system D as representative of a physical horizontal well to be located in the reservoir at the location indicated with respect to surface 136. FIG. 43C illustrates a display on the display screen 134 of indicating placement of a horizontal well 434 as indicated by the location of the object 432 on the of display hyper-dimensional image surface 136.

FIG. 44A illustrates computer controlled display screen 134 or hyper-dimensional surface 136 indicating reservoir data 440 of a region of interest like that of FIGS. 42A and 43A. FIG. 44B illustrates placement of a physical object 442 on hyper-dimensional surface 136. The physical object 442 is symbolically recognizable by the data processing system D as representative of a physical multi-lateral well to be located in the reservoir at the location indicated with respect to surface 136. FIG. 44C illustrates a display on the display screen 134 of indicating placement of multi-lateral well 444 as indicated by the location of the object 442 on the of display hyper-dimensional image surface 136.

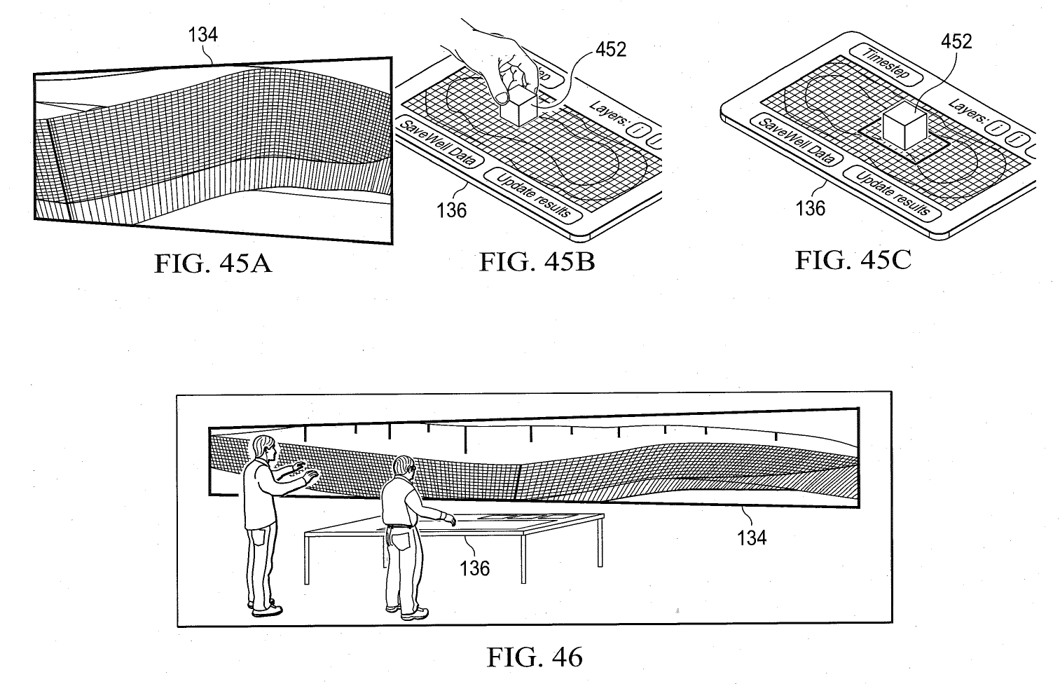

FIG. 45A illustrates computer controlled display screen 134 or hyper-dimensional surface 136 indicating reservoir data 450 of a region of interest like that of FIGS. 42A, 43A and 44A. FIG. 45B shows the hyper-dimensional surface 136 with a physical object 452 with respect to surface 136. The physical object 452 is symbolically recognizable by the data processing system D as representative of gridding or some other reservoir or data feature of interest with respect to the reservoir. FIG. 45C shows the visualization on surface 136 of the object 452 as data representations on the reservoir model of hyper-dimensional surface 136.

In the foregoing class of activities, physical objects (such as well objects, grid objects, etc.) are used to drive the reservoir and geosciences activities. The placement of physical objects on hyper-dimensional surface 136 translates to graphical and numerical representations of the physical object. In FIGS. 42A through 45C, the placement of vertical, horizontal and multi-lateral wells and gridding objects are illustrated.

### Multi-Disciplinary Class of Activities

### Both Local and Remote

In the multi-disciplinary class of activities shown in FIGS. 46 through 48, concurrent local collaboration between a reservoir engineer and geoscientist is provided in the initial design of a well in an existing reservoir with a number of wells present as indicated. The collaboration occurs by selecting a reservoir region of interest on virtual surface 136 in the manner described above. The reservoir engineer examines the flow simulation aspects and the geoscientist examines the reservoir characterization aspects of the initial well design. In FIG. 46, a reservoir engineer is illustrated examining flow simulation aspects of the reservoir region of interest on the vertical screen 134, and a geoscientist is shown examining the reservoir characterization on the virtual surface 136.

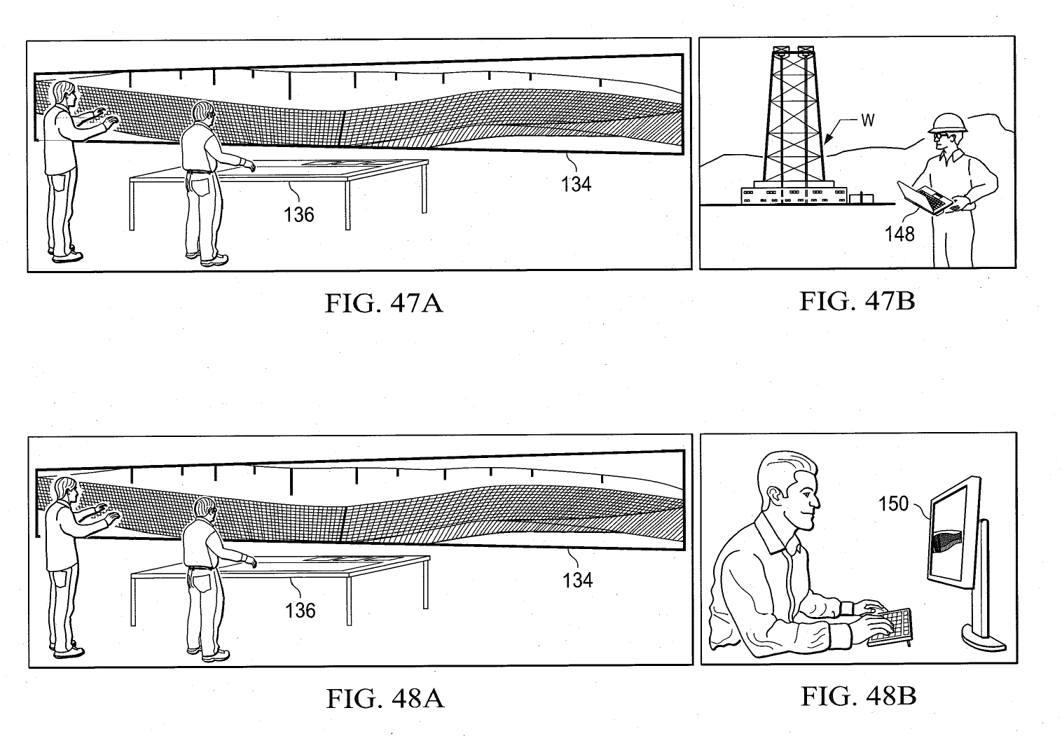

FIG. 47A shows a reservoir engineer examining the flow simulation aspects on the vertical screen 134 and the geoscientist examining the reservoir characterization on the virtual surface 136 in the manner illustrated in FIG. 46, and FIG. 47B shows a drilling foreman at a remote well site W examining the initial designs data on computer 148. Concurrent local and remote collaboration between a reservoir engineer and geoscientist (local) and a drilling foreman (remote) in the field studying the characteristics of the well to be drilled is thus provided. The reservoir engineer examines the flow simulation aspects, and the geoscientist examines the reservoir characterization aspects of the initial well design by methods similar to the concurrent local collaboration illustrated in FIG. 46. Modifications to the designed well may be made as a result of input from the drilling foreman at the well site W.

In FIG. 48A, a reservoir engineer is shown examining the flow simulation aspects on the vertical screen 134 and a geoscientist examining the reservoir characterization on the virtual surface 136 in the manner described above. FIG. 48B shows a production engineer at a remote location such as a satellite office concurrently examining the same reservoir and well information with computer 150. Concurrent local and remote collaboration between the reservoir engineer and geoscientist (local) and the production engineer (remote) in the satellite office studying a work-over scenario to manage water production from wells is thus provided. The reservoir engineer, geoscientist and the production engineer examine the well completions and are able to apply changes to selected well completions as a result of the collaboration to reduce water production from the reservoir.

### Reservoir Engineering and Geosciences Class of Activities that Use the Hyper-Dimension of Voice Instructions

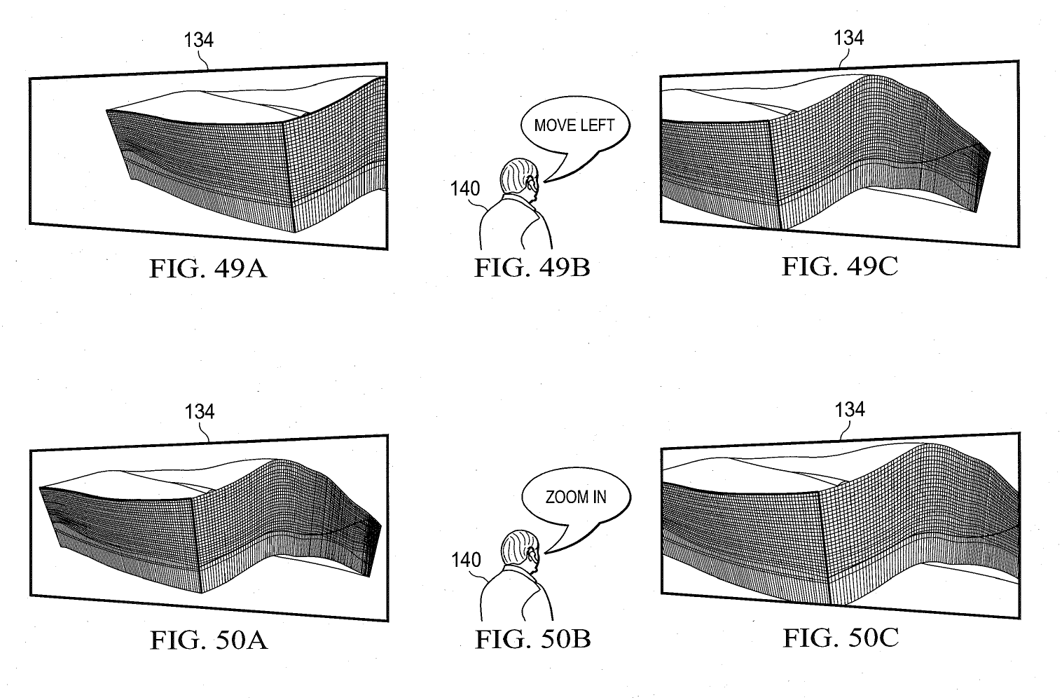

In this class of activities (FIGS. 49 through 86), the hyper-dimension of voice is provided for performing reservoir engineering and geosciences. FIG. 49A shows a display image on screen 134 of state of the reservoir horizontal or X-axis before navigation or movement. The image in display 134 is representative, and it should be understood that other data images described below regarding display screen 134 may be moved according the voice instruction class of activities herein described. FIG. 49B shows a voice command into audio input 140 by a user into audio input to the data processing system D that causes the data processing system to accomplish the required movement action. FIG. 49C shows the display screen 134 indicating results of the voice instructed navigation.

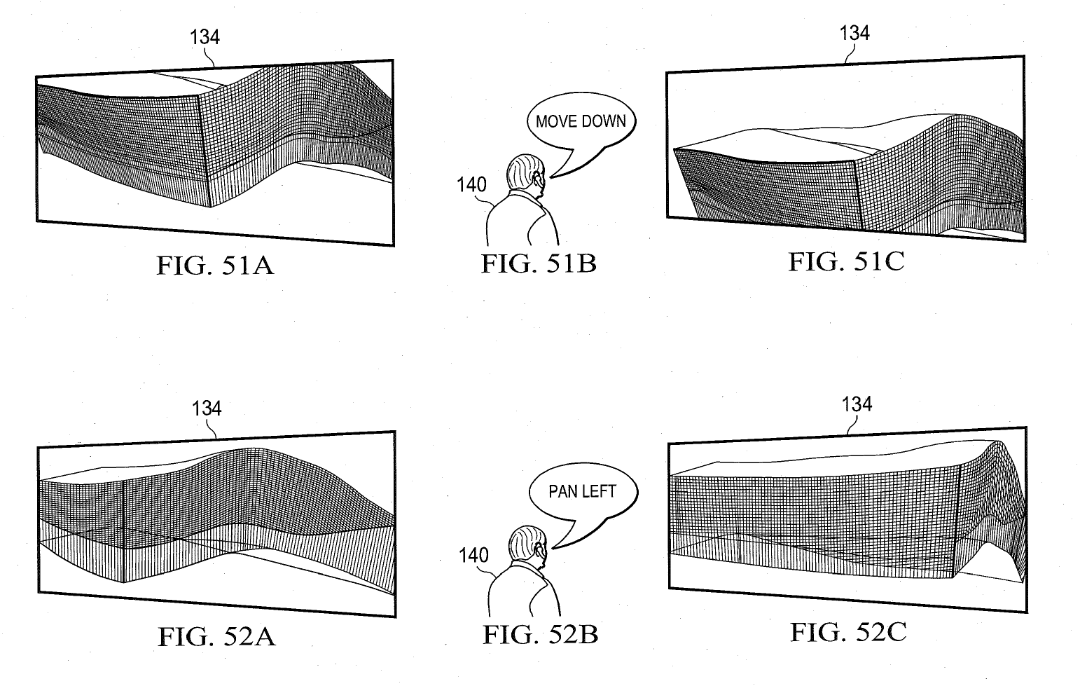

FIG. 50A shows the state of the reservoir image on display screen 134 before an inward or Y-axis navigation. FIG. 50B shows a voice command by a user into audio input 140 that identifies the required Y-axis navigation action. FIG. 50C shows the display screen 134 indicating the resulting voice instructed Y-axis position adjusted image which results from the navigation. FIG. 51A shows the state of the reservoir image on display screen 134 before a vertical or downward navigation. FIG. 51B shows a voice command by a user into audio input 140 that identifies the required downward navigation action. FIG. 51C shows the display screen 134 indicating the resulting voice instructed downward position.

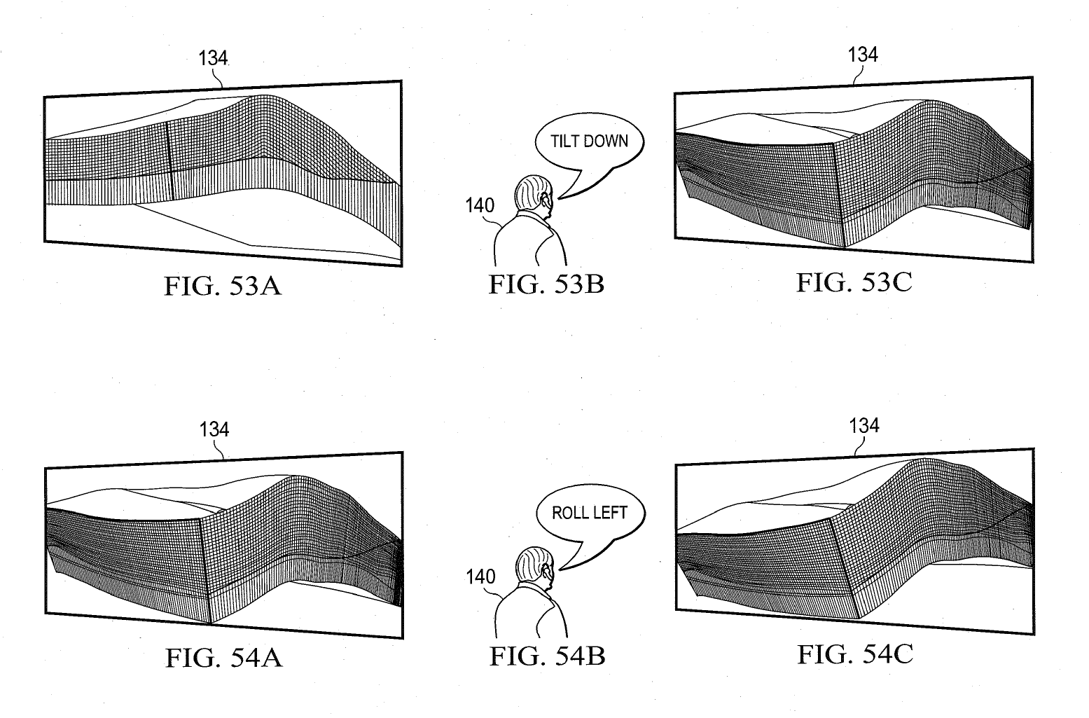

FIG. 52A shows an initial state of the reservoir image on display screen 134 before a panning or rotational movement of the reservoir image navigation. FIG. 52B shows a voice command by a user into audio input 140 that identifies the required action. FIG. 52C shows resulting voice instructed downward position adjusted image which results from the voice instruction. In FIG. 53A, the first window shows like FIG. 52A the state of an initial reservoir image. FIG. 53B shows a voice command by a user into audio input 140 that identifies the required tilting of the reservoir image on display screen 134. FIG. 53C shows the reservoir image on screen 134 which results from the tilting, initially exposing a previously hidden area of the reservoir.

FIG. 54A again shows an initial state of the reservoir image before a roll action is required. FIG. 54B shows a voice command by a user into audio input 140 that indicates the rolling action to be performed. FIG. 54C shows the adjusted reservoir image on display screen 134 as a result of the voice instructed roll action.

The reservoir activity of navigation in the horizontal plane from east to west; in the vertical plane from south to north; from front to back; of tilting the reservoir to observe the part of the reservoir that was previously not visible; and of panning in the reservoir; of rolling to enter the reservoir to give an immersive effect as illustrated in FIGS. 49A through 54C. Thus, the present invention permits use of sound as a hyper-dimension to identify actions to be taken with respect to a displayed image. The use of sound or audio input increases productivity of users in the analysis of reservoir data for reservoir images in reservoir engineering and geosciences. Again, the capability provided by the present invention is significant.

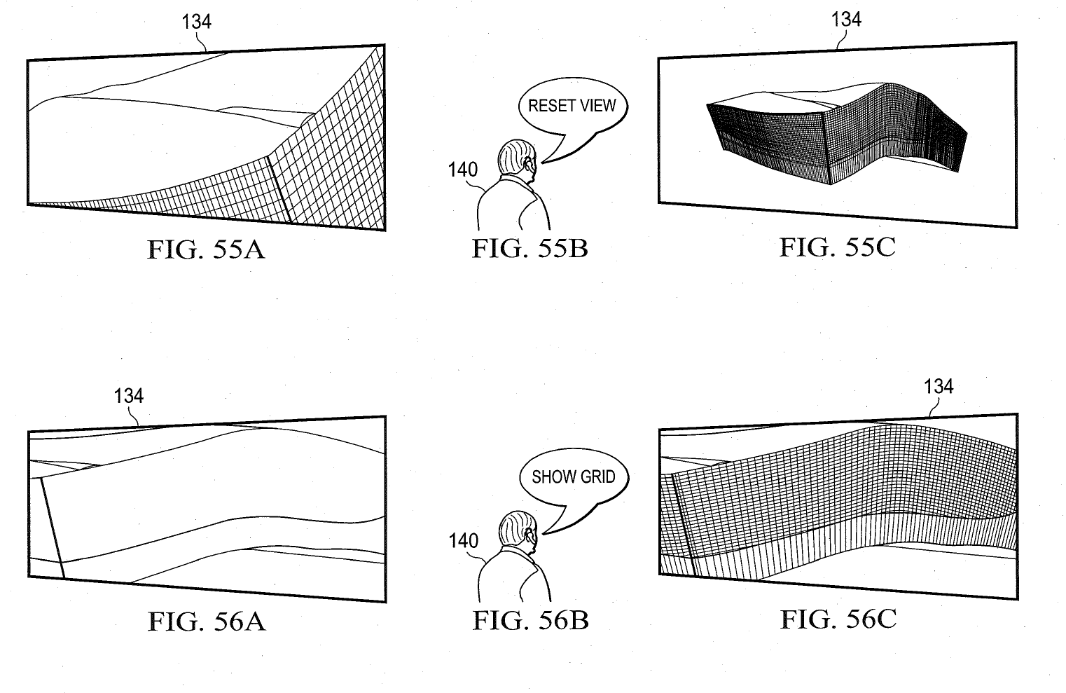

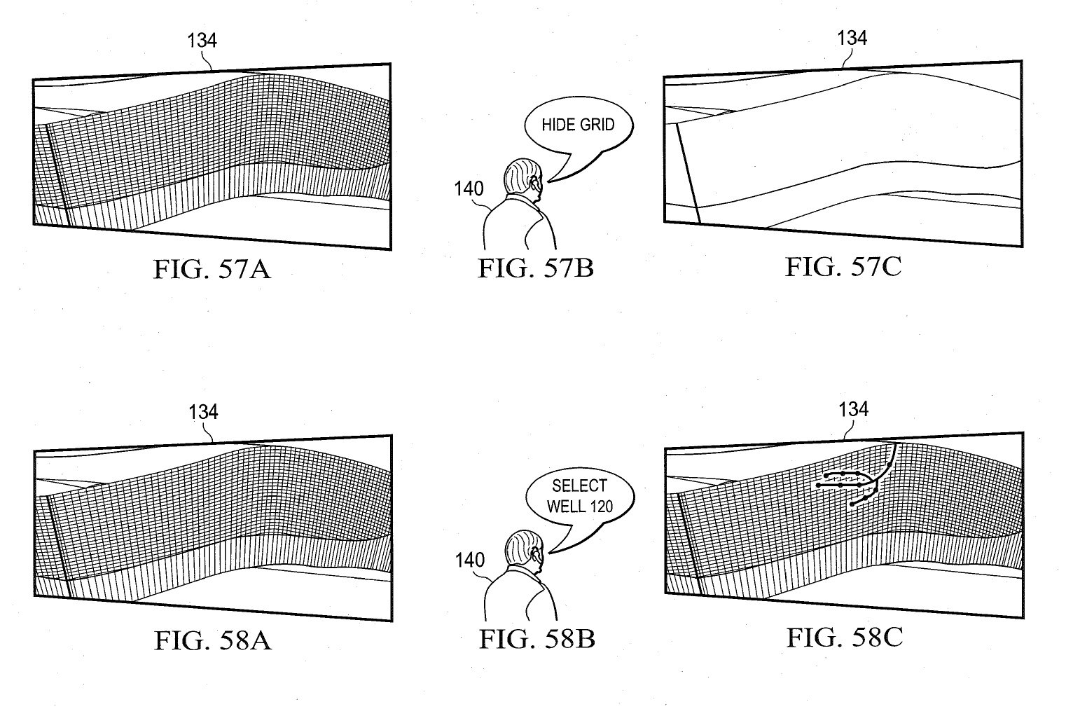

FIG. 55A shows the current state of an image the reservoir before issuance of a voice reset command. FIG. 55B shows a voice command by a user into audio input 140 that indicates the resetting action is to be performed. FIG. 55C the reservoir image restored to its initial state from that of FIG. 55A. FIG. 56A shows a current state of the reservoir without a simulation grid. FIG. 56B shows a voice command by a user into audio input 140 to include such a grid. FIG. 56C shows the reservoir simulation grid having been placed on the reservoir image according to the voice command. FIG. 57A shows a display of the reservoir like that of FIG. 56C with a grid present, and FIG. 57B a voice command by a user into audio input 140 to conceal or remove the grid. FIG. 57C the reservoir model with the simulation grid of FIG. 57A having been concealed or hidden as requested.

The present invention thus in response to voice instructions, restores an image of the reservoir to its initial state; places a simulation grid on the reservoir model; and removes a simulation grid from the reservoir model through a voice instruction, as illustrated in FIGS. 55A through 57C.

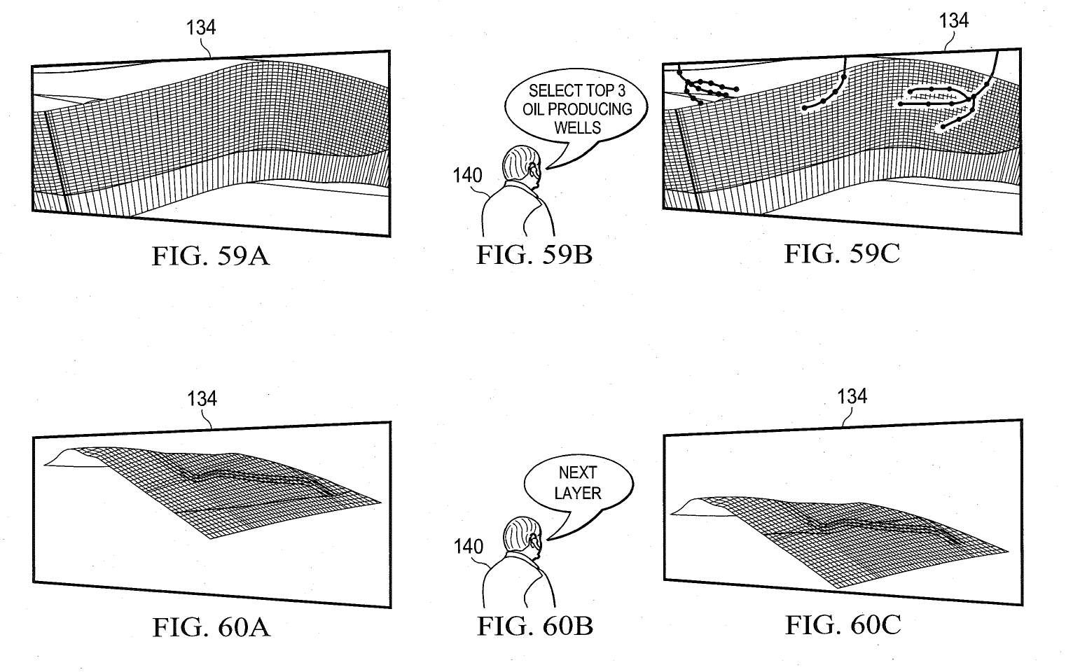

FIG. 58A shows a display of a reservoir image in an area of interest. FIG. 58B shows issuance of a voice command by a user into audio input 140 to display an identified well. FIG. 58C shows a display of the reservoir with the identified well present as a result of the requested action. FIG. 59A shows a display of a reservoir image of an area of interest. FIG. 59B shows issuance of a voice command by a user into audio input 140 to display a group of wells with certain production criteria. FIG. 59C shows a display of the reservoir of wells which conform to the stated criteria. The present invention thus in response to voice instructions provides for selecting a well in the reservoir; locking in the selected well; selecting several wells by name or stated criteria in a region of the reservoir via call-out instructions; and locking in the wells in the selected region as illustrated in FIGS. 58A through 59C.

The present invention also provides the capability with the data processing system D to cause in response to voice commands the displaying of the model/geologic layers one at a time until all the layers is traversed; selecting a particular layer of interest; displaying the model/geologic X-direction cross-sections, one at a time until all the X-direction cross-sections are traversed; selecting a particular X-direction cross-section of interest; displaying the model/geologic Y-direction cross-sections, one at a time until all the Y-direction cross-sections are traversed; and selecting a particular Y-direction cross-section of interest as illustrated in FIGS. 60A through 65C and described below.

FIG. 60A shows a display of a geologic layer of interest. FIG. 60B shows a display of the requested next layer in response to a statement of voice instructions by a user into audio input 140 that identify the action to be taken, in this case, the display of a next layer.

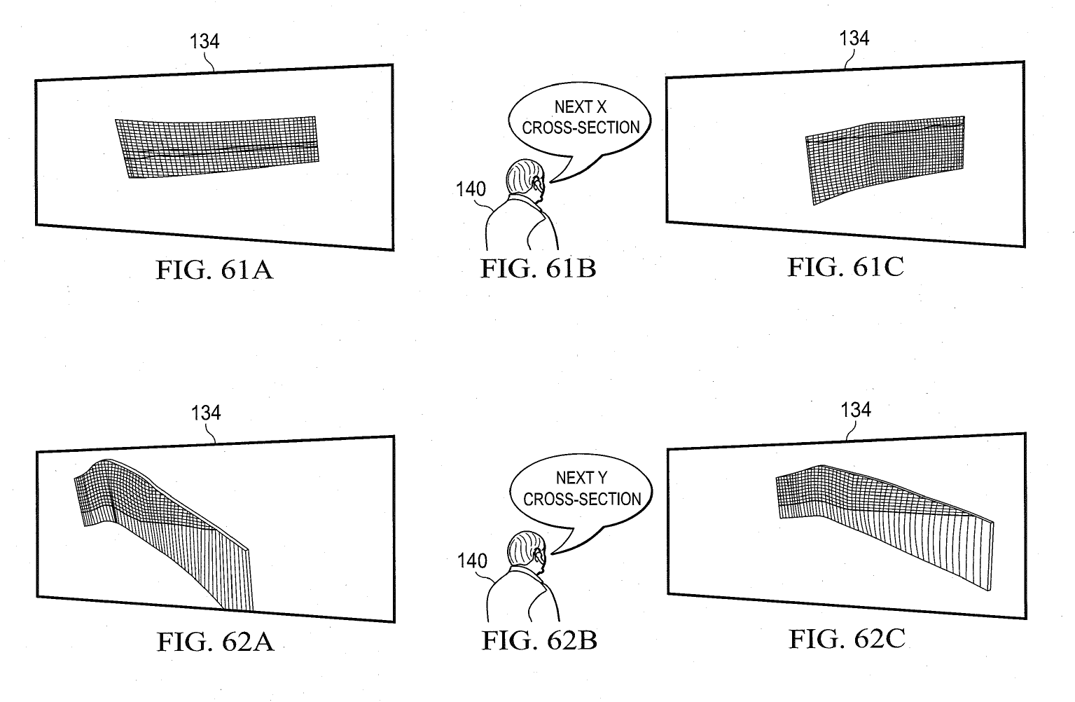

FIG. 60C shows the results of the action taken. FIG. 61A illustrates an initial reservoir X-cross section display. FIG. 61B shows the giving voice instructions by a user into audio input 140 stating a request to show the next X cross-section. FIG. 61C shows the next X-cross section as a result of the stated action.

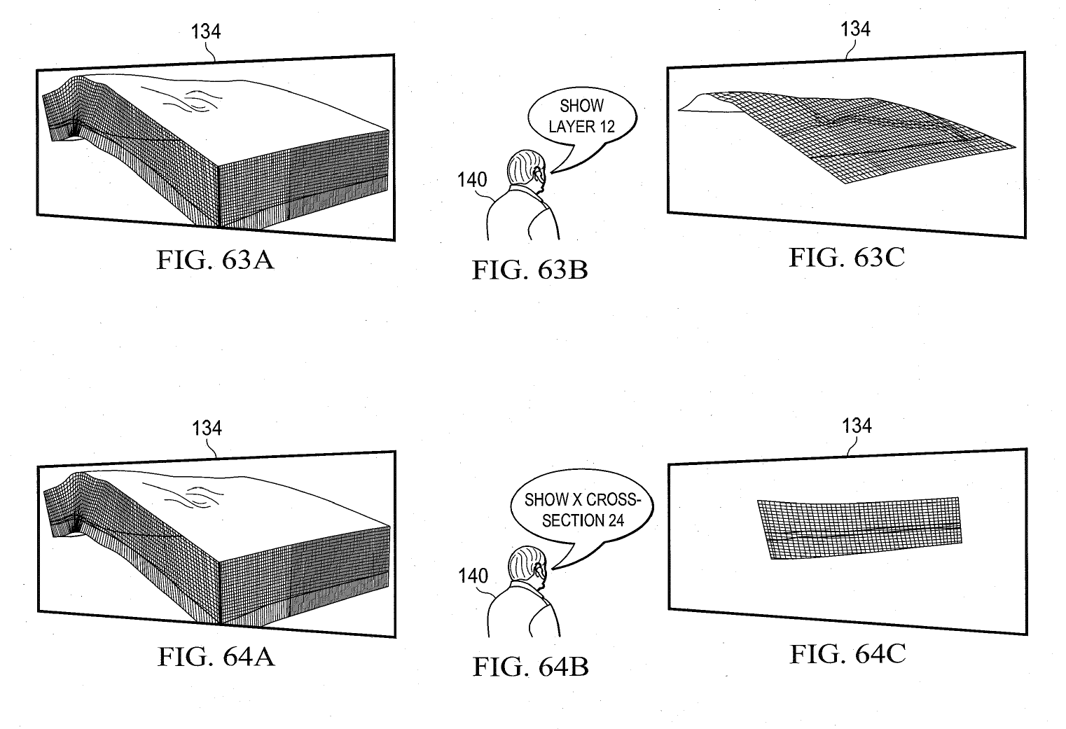

FIG. 62A shows an initial Y cross-section of the reservoir. FIG. 62B shows the voice command into audio input 140 to move to the next Y cross-section, and FIG. 62C shows the result of the stated action. FIG. 63A shows an initial display of the reservoir in an area of interest. FIG. 63B shows a statement of voice instructions by a user into audio input 140 that identify a specific layer in the data display to be shown. FIG. 63C shows a display of the identified layer.

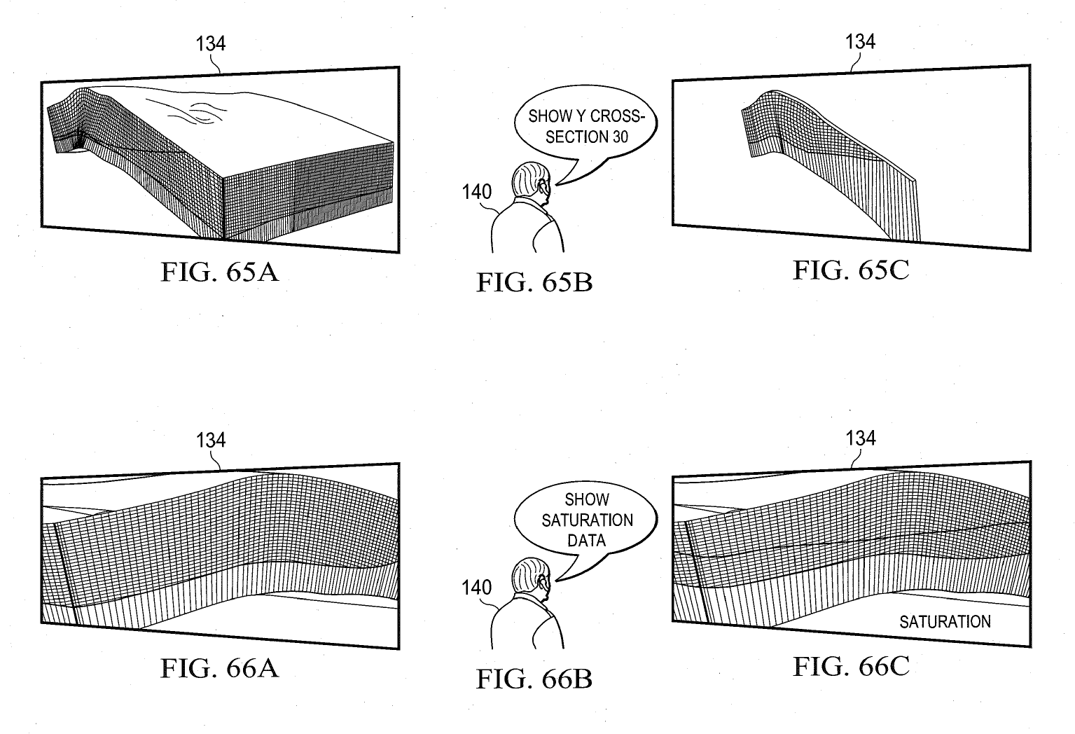

FIG. 64A, like FIG. 63A, shows an initial display of the reservoir data. FIG. 64B shows voice instructions into audio input 140 to display an identified X cross-section from the image shown in FIG. 64A. FIG. 64C shows a display of the identified X cross-section. FIG. 65A similarly shows an initial display of the reservoir, while FIG. 65B shows giving of voice instructions to display an identified Y cross-section. FIG. 65C shows a display of the identified Y cross-section.

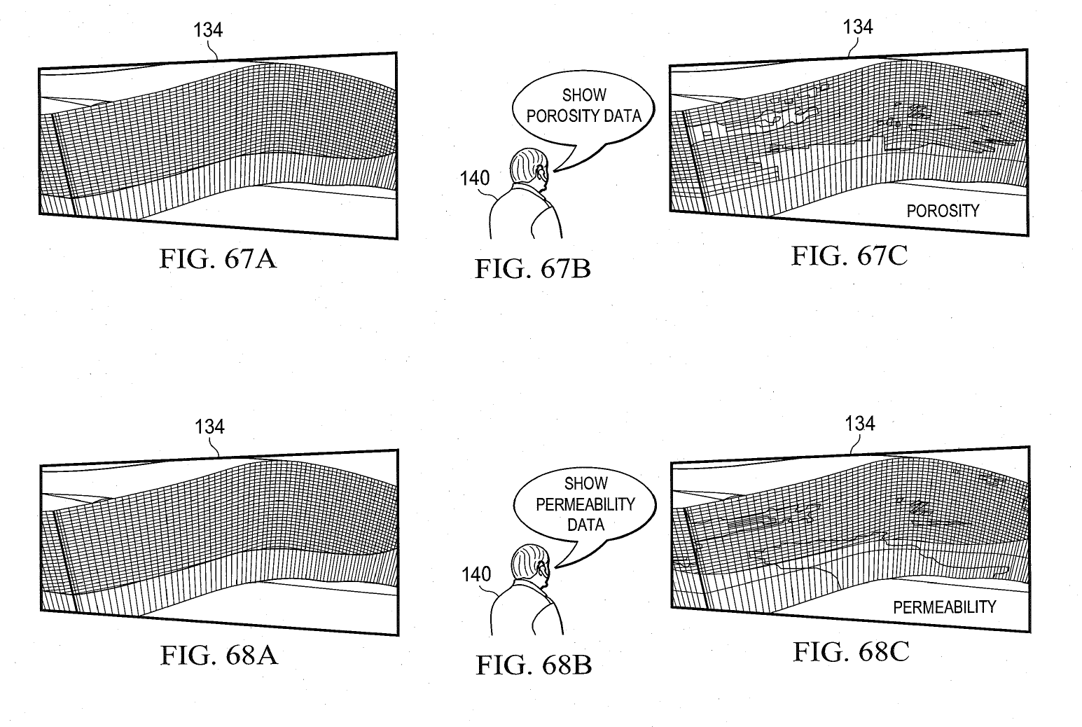

FIG. 66A shows a display of a simulation grid in a region of interest of the reservoir. FIG. 66B shows issuance of a voice instruction into audio input 140 to show ternary saturation data on the reservoir display. FIG. 66C shows a display of the ternary saturation in the area of the reservoir simulation grid shown in the display. Similarly, FIG. 67A shows a display of a simulation grid like that of FIG. 66A. FIG. 67B shows giving of voice instruction into audio input 140 to show porosity data in the display of FIG. 67A. FIG. 67C shows the porosity distribution in the reservoir display. FIG. 68A, as in FIGS. 66 and 67, shows a simulation grid in a reservoir area of interest. FIG. 68B shows a statement of a voice instruction to show permeability data for the area displayed. FIG. 68C shows the identified permeability distribution in the displayed area of the reservoir.

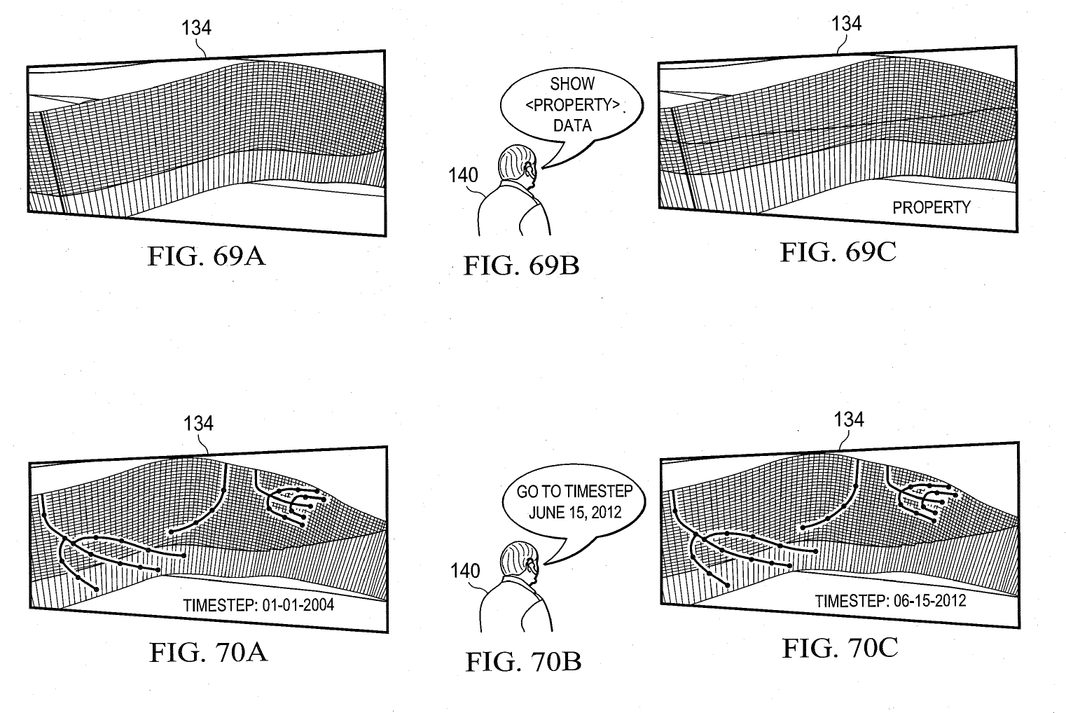

FIG. 69A again shows an area of interest as simulation grid. FIG. 69B shows the statement of a voice instruction to show data indicative of some other identified property than saturation, porosity or permeability for the area displayed. FIG. 69C shows the identified property distribution in the displayed area of the reservoir.

Selecting a ternary saturation of oil-gas-water to examine the current state of the reservoir with respect to the ternary saturation; selecting the porosity distribution to examine the current state of the reservoir with respect to the porosity; selecting the permeability distribution to examine the current state of the reservoir with respect to the permeability; selecting an arbitrary property of the reservoir to examine the current state of the reservoir with respect to the arbitrary property are invented and illustrated in FIGS. 66A through 69C.

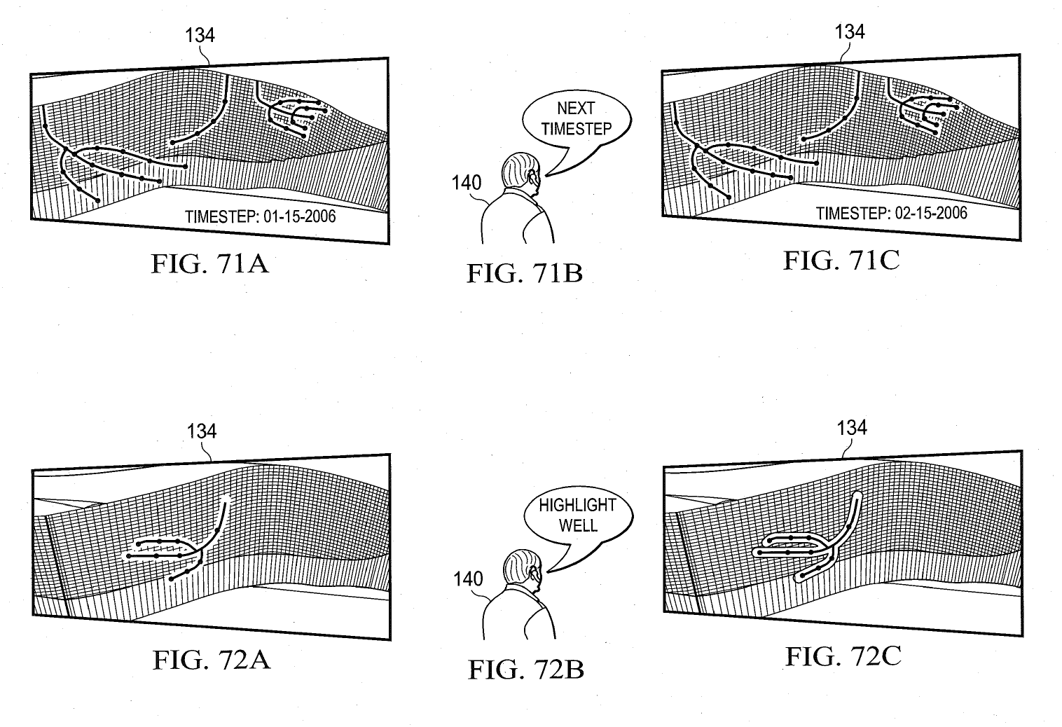

FIG. 70A shows a display of reservoir simulation data at some selected time in the reservoir simulation cycle. FIG. 70B shows giving a voice instruction by a user into audio input 140 to move to another identified time in the reservoir simulation, and FIG. 70C shows the results of translating the reservoir simulation in time. FIG. 71A shows the reservoir simulation data at a specific time in a simulation. FIG. 71B shows the voice instruction into audio input 140 to advance to the next time step in the simulation, and FIG. 71C shows the simulation data results at the selected time. The present invention provides observing changes in the reservoir over the simulated production life as a function of time as a result of production and injection; and pausing and observing the properties of the reservoir at a selected time

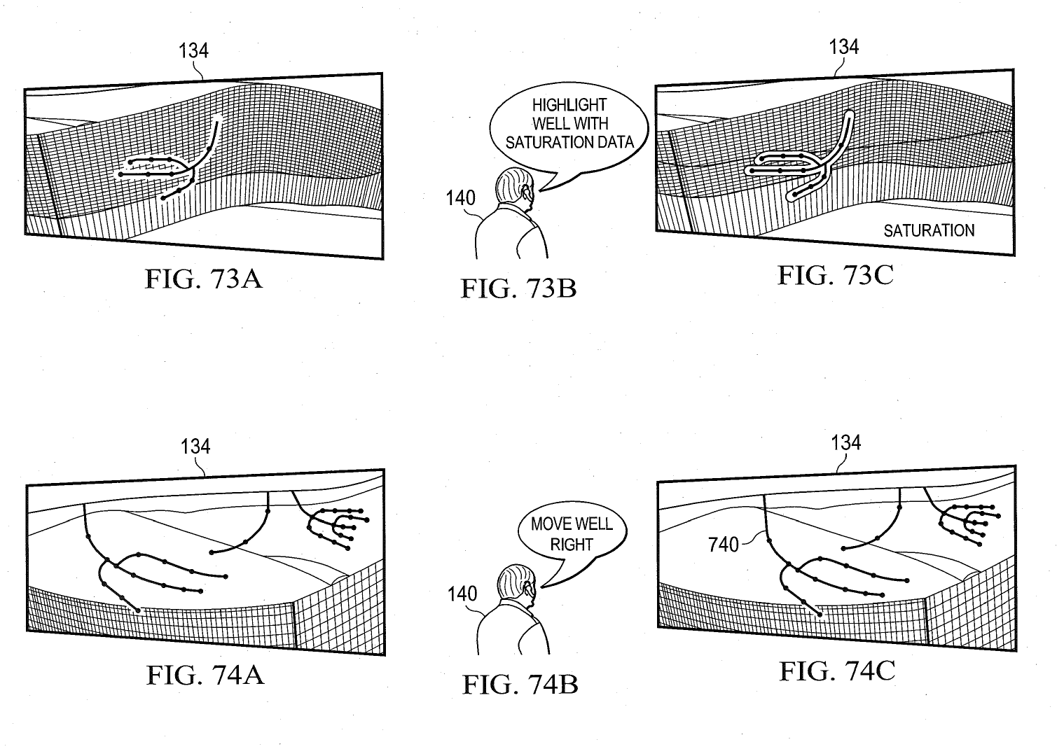

FIG. 72A window shows a display of reservoir data at the location of a well path 720 of interest. FIG. 72B shows the voice instruction into audio input 140 to highlight an identified well, and FIG. 72C shows the well path 720 after being highlighted. FIG. 73A shows the identified well resulting 720 as shown in FIG. 72. FIG. 73B shows the voice instruction into audio input 140 to display saturation data in the area of the identified well 720, and FIG. 73C shows ternary saturation along the well path of the identified well 720. Accordingly, as shown in FIGS. 72A through 73C a well path is identified to examine the nature of the fluids flowing into the well. The present invention thus provides observing the ternary saturation of oil-gas-water to examine on the basis of specific time steps the current state of production from the well as shown in FIGS. 72 through 73.

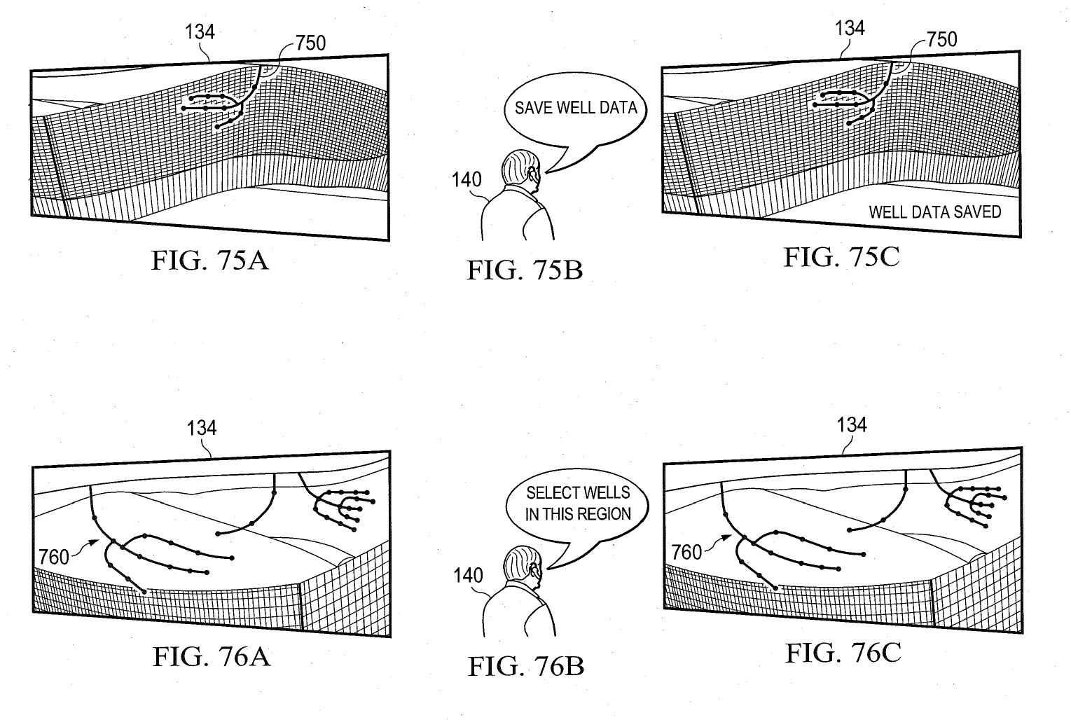

FIG. 74A shows a display of a current location of a well 740 of interest among others in simulation data, and FIG. 74B window shows a voice instruction by a user with audio input 140 to-relocate the well. FIG. 74C shows a display of the selected well 740 in the new location. FIG. 75A shows a re-located well 750, and FIG. 75B shows a voice instruction to write to memory file in the data processing system D the new location of the well 750. FIG. 75C shows a display indicating that the file that has been written to memory. The present invention allows a user to pick a well in the reservoir by calling out the well name and issuing a voice command to select the well, and re-locate the selected well by issuing a sequence of voice commands to specify the coordinates of the new location and the drop off or positioning instruction; and the process of communicating the well-relocation to reservoir simulator data memory using a voice instruction to write the new location of the re-located well to a well memory file as illustrated in FIGS. 74A through 75C.

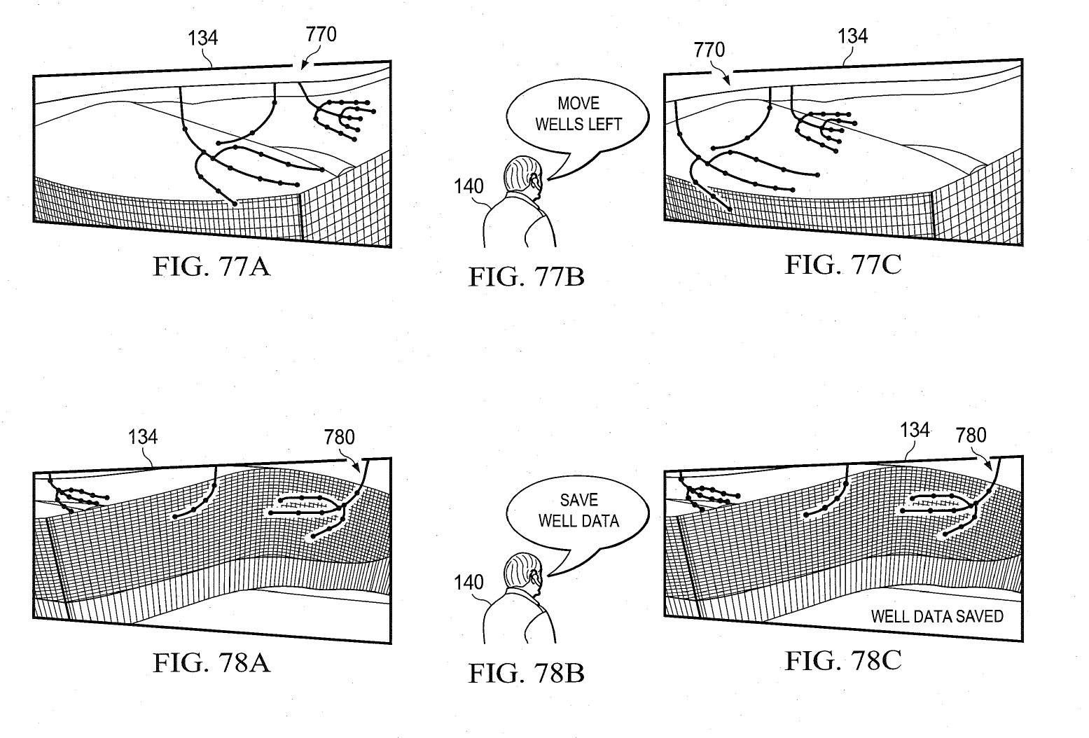

FIG. 76A shows a display of reservoir data indicating current locations of a group of wells 760 in simulation data of a region of interest in the reservoir, and FIG. 76B shows a voice instruction to select the wells 760 in the display to a desired region. The third window shows the selected wells 760. FIG. 77A shows the current location of a selected group of wells 770 like those of FIG. 76C, while FIG. 77B shows a voice instruction for picking and moving the wells 770. FIG. 77C shows the selected wells 770 as moved to the new specified location. FIG. 78A shows a display of wells 780 as relocated according to FIG. 77B. FIG. 78B shows voice instruction to write or save to reservoir simulator data memory in data processing system D the new locations of the wells 780, and FIG. 78C shows a display to indicate the file data has been so written.

The present invention affords a computer implemented process for picking several wells in a region of the reservoir by calling out the well names and issuing voice instructions to add the wells to a list; re-locating the picked wells in the region of the previous step by issuing voice instructions to take the list of collected wells of the previous step to the new desired location and ‘dropping off’ the wells at the new location; and of communicating the well-relocations to the reservoir simulator using a sequence of voice instructions to write the new locations of the re-located wells to a well file as shown in FIGS. 76A through 78C.

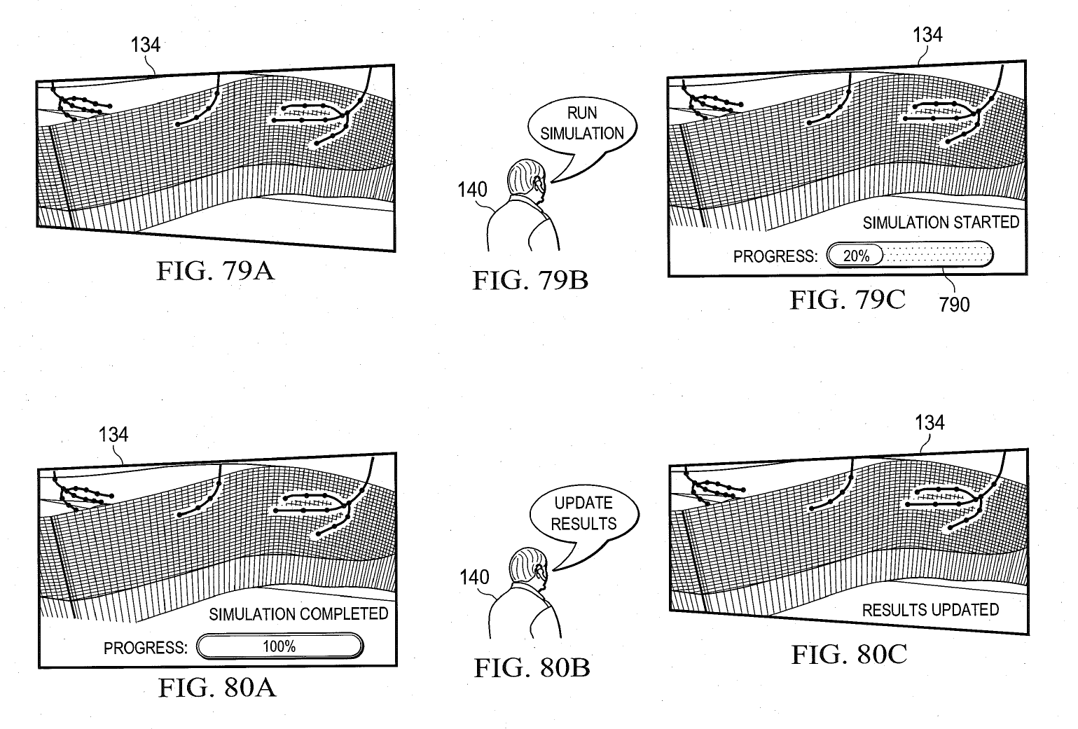

FIG. 79A shows a display of reservoir simulation data at a specified time before a simulation run cycle. FIG. 79B shows the issuance of a voice instruction to start simulation, and the third window shows the simulation running with a progress indicator 790. FIG. 80A shows the current time well performance on completion of the simulation run requested according to FIG. 79B. FIG. 80B shows a voice instruction to update in memory the simulation results, and FIG. 80C shows a display indicating the results have been so updated. Thus, the present invention permits starting a simulation run time from a time when the wells have been re-located by actions shown in FIGS. 76 through 78 by issuing a voice command to run the simulation; as well as, monitoring and updating the simulation results through a series of voice instructions as illustrated in FIGS. 79A through 80C.

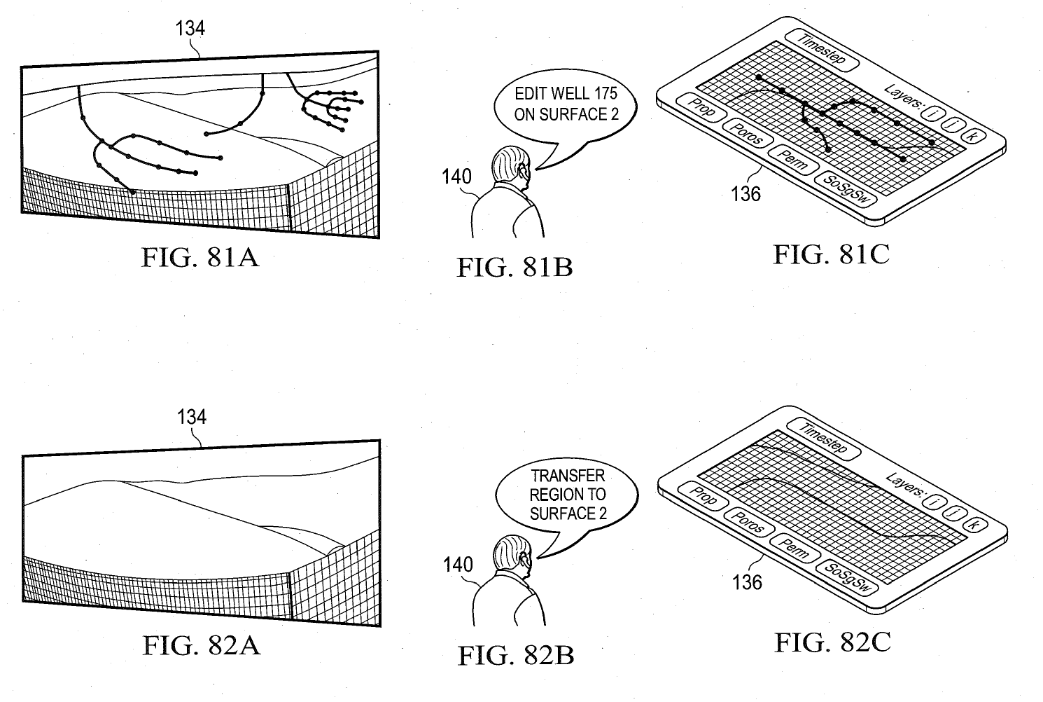

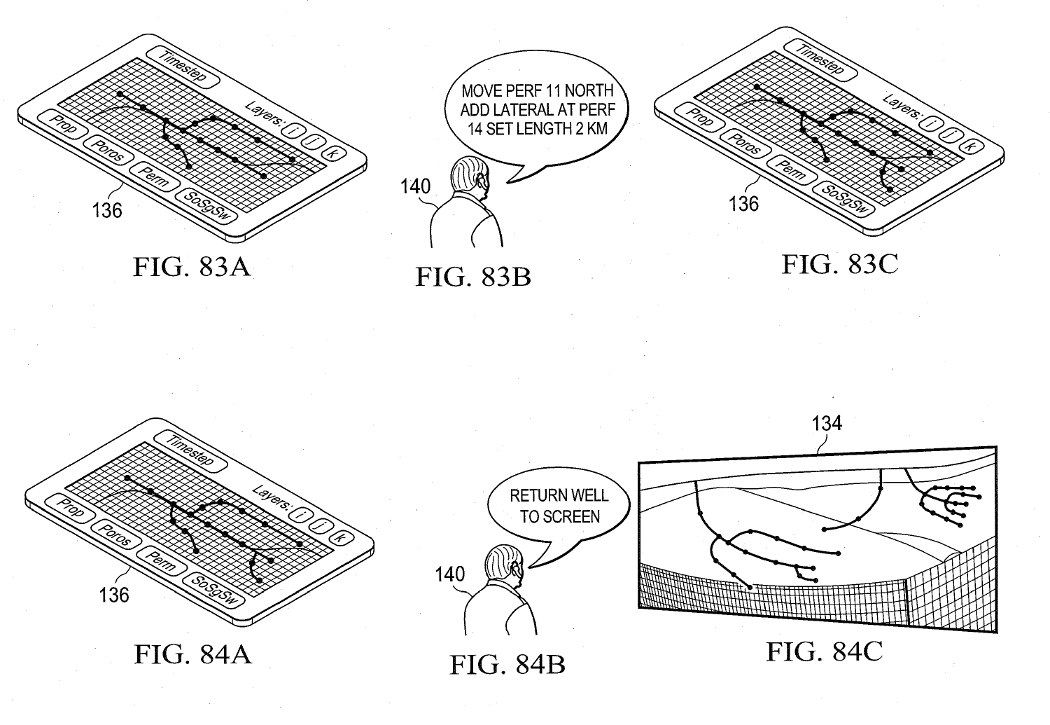

FIG. 81A shows a display of reservoir data of a specified well on the vertical screen 134, and FIG. 81B illustrates the statement by a user of a voice instruction to bring the specified well data to the hyper-dimensional surface 136. FIG. 81C shows the specified well data displayed on the hyper-dimensional surface 136. FIG. 82A shows a display of a region of interest in the reservoir on the vertical screen 134, and FIG. 82B illustrates a voice instruction to bring the region of interest to the hyper-dimensional surface 136. FIG. 82C shows the region of interest on the hyper-dimensional surface 136. FIG. 83A shows a current well configuration 830 on surface 136, and FIG. 83B illustrates an example re-designing process through a series of voice instructions. FIG. 83C window shows a re-designed well 831 on the hyper-dimensional surface 136. FIG. 84A shows the re-designed well 831 on the virtual surface 136, the FIG. 84B shows a voice instruction to return the re-designed well 831 from display 136 to the screen 134. FIG. 84C shows the re-designed well 831 in the parent reservoir on screen 134.

The present invention provides a computer implemented process for marking out a region around an existing well (FIG. 81A) that is earmarked for re-design from the vertical screen, encapsulating this region and bringing this region to a hyper-dimensional surface 136 through a series of voice instructions. The present invention allows a computer implemented process for selecting a location for designing a new well, marking of a window around the selected well location on the vertical screen 134, encapsulating this window and bringing this region to hyper-dimensional surface 136 through a series of voice instructions; as shown in FIG. 82B. In addition, the present invention provides for computer implemented re-design of a well at a selected location on the hyper-dimensional surface 136, through a series of voice instructions (FIG. 83B) that includes undo and/or re-do of the re-design steps; and the return of the newly re-designed well from the virtual surface back to the parent reservoir on the screen 134 (FIG. 84C) by issuing voice instructions through audio input 140.

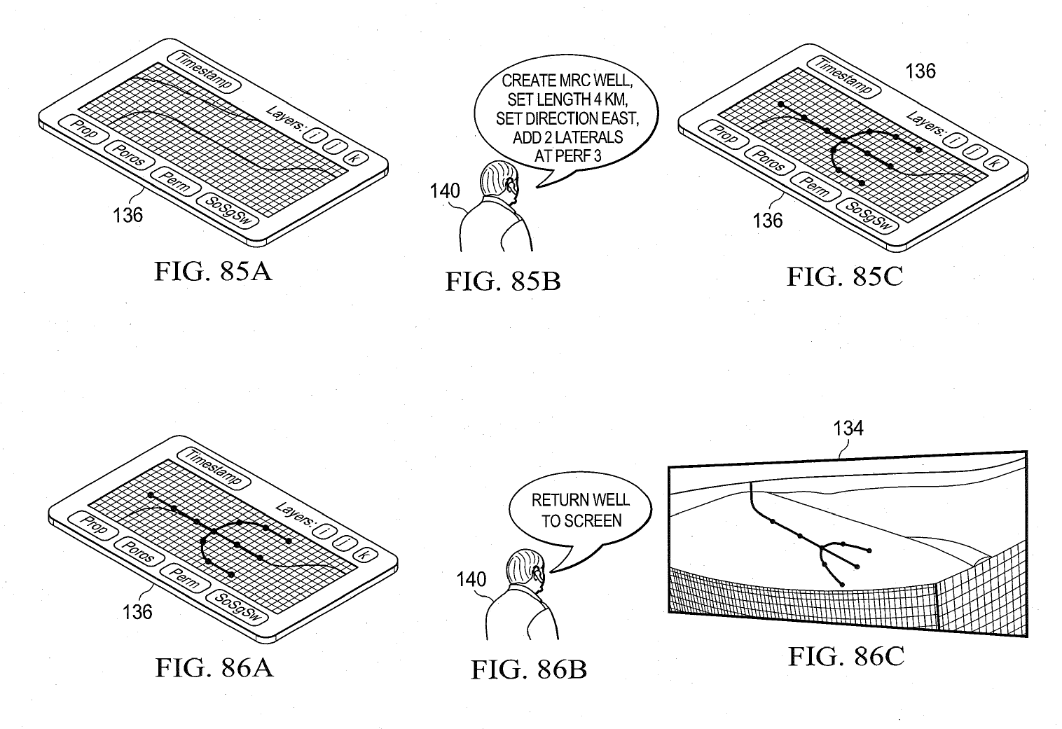

FIG. 85A shows a display of a chosen region from the reservoir on the hyper-dimensional surface 136 while FIG. 85B illustrates a well designing process through a set of voice instructions through audio input 140. FIG. 85C shows a resultant designed well 850 on the hyper-dimensional surface 136. FIG. 86A shows the newly designed well 850 of FIG. 85C on the virtual surface 136, and FIG. 86B shows a request to transfer data for the well 850 from the virtual surface 136 back to the parent reservoir on the screen 134 by issuing voice instructions through audio input 140. FIG. 86C shows the new well 850 in the parent reservoir on screen 134.

Accordingly the present inventions provide for computer implemented, audio instruction controlled design of a new well, from scratch, at a selected location on the hyper-dimensional surface 136, through a series of voice instructions that includes undo and/or re-do of the design steps; data memory for display; and the return of the newly designed well from the virtual surface 136 to the parent reservoir on the screen by issuing voice instructions as illustrated in FIGS. 81A through 86C.

### Computer Implemented Process

A flow chart F (FIG. 87) composed of a set of data processing steps illustrates the structure of the logic of the present invention as embodied in computer program software. The flow chart F is a high-level logic flowchart which illustrates a method of processing interchange of data requests and resultant displays of data for modeling and simulation of subsurface bodies and their fluid contents data in connection with reservoir engineering and geosciences. Those skilled in the art appreciate that the flow charts illustrate the structures of computer program code elements that function according to the present invention. The invention is practiced in its essential embodiment by computer components that use the program code instructions in a form that instructs a digital data processing system D (FIGS. 88 and 89) to perform a sequence of processing steps corresponding to those shown in the flow chart F.

The flow chart F of FIG. 87 contains a preferred sequence of steps of a computer implemented method or process for responding to input requests from users of the data processing system D. As has been described above, the input requests take the form of hand or body gestures; voice commands; hovering actions; placement of physical objects on hyper-dimensional surfaces; and input signals from local or remote users of computers furnished to the data processing system D by a computer communication and information transfer network. The computer communication network may be a wide area network, a local area network, and either wireless or optical cable.

The flow chart F is a high-level logic flowchart illustrates a method according to the present invention. The method of the present invention performed in the computer 120 (FIG. 88) of the data processing system D can be implemented utilizing the computer program steps of FIG. 87 stored in memory 124 and executable by system processor 122 of computer 120. The reservoir data in processing system D take the form of reservoir data as herein defined, including both reservoir, geological and seismic models. As will be set forth, the flow chart F illustrates a preferred embodiment of simulation and presentation of reservoir data to users of the data processing system D to permit hyper-dimensional simulation and evaluation for reservoir engineering and geoscientific purposes.

During step 98 (FIG. 87) of the flow chart F, the reservoir data is loaded in the memory of data processing system D. The data of interest is then processed onto displays of the data processing system D (FIGS. 88 and 89) including display screens 134, virtual surfaces 136 and computer systems such as computers 148 (FIG. 47) and 150 (FIG. 48), for example.

During step 100, input requests provided by a user of the data processing system D are recognized in a user interface 126 (FIGS. 88-89). The input requests may be hand gestures or poses, or actions taken with respect to the virtual display 136, voice commands, or other inputs described above in FIGS. 1B through 86B. The input requests are then transformed or translated into appropriate digital code format and transferred as data requests to the processor 122. During step 102, the data specified by the data requests is then called from memory in the data processing system D and processed or operated on according to the data request.

During step 104, the requested data is then arranged for display according to the nature of the input request, based on the nature and content of the data request as determined during step 102. During step 106, the resultant arranged data from step 104 are updated and made available on the displays, virtual surfaces and computer systems described above for presentation as output images or displays of the types illustrated in FIGS. 1 through 86 for interpretation and analysis. As has been set forth, the output images are made available both as virtual displays and as screen images on display monitors, screens or panels. The data processing system D then returns to step 100 in response to another input request gesture, signal or command. In the event that an exit command is furnished as indicated at step 108, the data processing system D then ceases performing the processing steps of the flow chart F.

### Data Processing

As illustrated in FIG. 88, a data processing system D according to the present invention includes a computer 120 having a processor 122 and memory 124 coupled to the processor 122 to store operating instructions, control information and database records therein. The computer 120 may, if desired, be a portable digital processor, such as a personal computer in the form of a laptop computer, notebook computer or other suitable programmed or programmable digital data processing apparatus, such as a desktop computer. It should also be understood that the computer 120 may be a multicore processor with nodes such as those from HP, Intel Corporation or Advanced Micro Devices (AMD), or a mainframe computer of any conventional type of suitable processing capacity such as those available from International Business Machines (IBM) of Armonk, N.Y. or other source.

The computer 120 has a user interface 126 (FIGS. 88-89) which responds to input requests from users in the form of hand or body gestures or gestures; voice commands; virtual hovering or pointing actions; placement of physical objects on hyper-dimensional surfaces; and input signals from local or remote users of computers of the types described above. The input requests from users are transformed into computer acceptable code format for transfer to the processor 122. The user interface 126 displays reservoir data furnished from memory of the computer 120 as simulations to users as requested for analysis and interpretation. The user interface 126 also receives signal inputs from local or remote users of computers for analysis and interpretation.

The user interface 126 includes a suitable number of video sensors or cameras 128 arranged about a viewing area 130 which represents the spatial operating environment (SOE) to form video images of user input gestures or poses of the types illustrated above in FIGS. 1B through 10B, 14B through 19B, 24B through 26B, 28B-29B, 31B-32B, 36B-37B, 39B, 41B and 46-48. The video signals of the user gestures are transferred from sensors/cameras 128 to gesture translation and processing module 132 and then converted into computer acceptable code format identifying the nature of the user request and the portions of the reservoir data to be presented as simulation features or objects to the user(s) for evaluation and interpretation. The viewing area 130, sensors/cameras 128 and gesture translation and processing module 132 may, for example, be of the type described in U.S. Pat. No. 7,598,942 and operate in the manner therein described.

The reservoir data specified by the user input requests is called from memory of the data processing system D and furnished by processor 122 to a screen display 134 (FIG. 89) and the requested reservoir data is made visible to users as shown in FIGS. 1 through 86. As has been set forth, several screen displays may be used, if desired.

Reservoir data of interest identified by user requests is also made available in the user interface 126 as a virtual image on a virtual image surface 136 in or near the viewing area 130. Virtual display surface 136 is a physical surface located within the spatial operating environment (SOE) or viewing area 130. As has been set forth, the virtual display surface 136 is a background such as an ordinary table or other suitable surface. One or more projectors 138 located above the table or surface project the current data of interest as requested onto the table or surface. It should also be understood that video monitors such as television screens or panels or display panels can also serve as display surfaces.

The reservoir data identified for display as a virtual image on the virtual image surface 136 is provided by processor 122 to the projectors 138 which form virtual images (FIGS. 10-13, 17-23, 27, 30, 33-35 and 37-48) of the requested data on the virtual image surface 136. The virtual image surface 136 is, preferably located with respect to projectors 138 at an appropriate height and orientation. The virtual image surface is also responsive to hovering actions by users at locations to convey data requests and restrictions to the processor 122 for performance. As has been described above, the virtual image surface is also responsive to user input request in the form of users' hovering action towards designated areas of the virtual image display (FIGS. 17-23, 27, 30, 33-35). Further, there may be more than one virtual image present, as has been mentioned.

The user interface 126 also includes an audio input/output unit 140 (FIGS. 48-86) with which a user may state voice commands or instructions regarding the reservoir data of interest to be displayed. The user may also hear from the audio unit 140 sounds indicative of reservoir conditions as described in commonly owned U.S. Pat. No. 7,620,534. Voice or audio commands received by audio input 140 are digitized and transformed into computer acceptable code format in the conventional manner in an audio to digital conversion circuit 142 and transferred as data requests to the processor 122. The reverse procedure is performed in circuit 142 for audio output. The reservoir identified by the audio commands is made available on display 134 and virtual image surface 136, as specified. Examples of displays formed in response to voice instructions or commands are set forth in FIGS. 49-86.

The user interface 126 includes a network interface or bus 146 which connects the data processing system D to a computer communication network which, as described, may be a wide area network, local area network, and either wireless or cable. In this way, a computer 148 (FIG. 47) of a remote user at a well site and/or a computer 150 (FIG. 48) of a reservoir engineer or geoscientist in a satellite office may concurrently study reservoir data at those locations as others are evaluating the same reservoir data on display 134 and virtual image surface 136. The user interface typically also includes, as is conventional, keyboard and mouse controls 152 for the usual and customary activation, maintenance and housekeeping functions of the data processing D.

Data processing system D further includes a database 160 containing the various types of reservoir data described above stored in computer memory, which may be internal memory 124, or an external, networked, or non-networked memory as indicated at 162 in an associated database server 164.

The data processing system D includes program code 166 stored in memory 124 of the computer 120. The program code 166, according to the present invention is in the form of computer operable instructions causing the data processor 122 to form images or reservoir data requested by user gestures, poses or voice commands, has been set forth.

It should be noted that program code 166 may be in the form of microcode, programs, routines, or symbolic computer operable languages that provide a specific set of ordered operations that control the functioning of the data processing system D and direct its operation. The instructions of program code 166 may be may be stored in memory 124 of the computer 120, or on computer diskette, magnetic tape, conventional hard disk drive, electronic read-only memory, optical storage device, or other appropriate data storage device having a non-volatile computer usable medium stored thereon. Program code 166 may also be contained on a data storage device such as server 164 as a computer readable medium, as shown.

From the foregoing it can be seen that according to the present invention the term geoscience in the preferred embodiment is described in relation to the oil and gas Industry, namely geology and geophysics and its derivatives such as geo-steering, and the like. However, it should be understood that the principles and operations described herein could include any other geoscience or earth science where modeling and simulation are practiced or utilized.

It can also be seen that the present invention provides a hyper-dimensional simulation system that makes available a direct and natural approach for performing reservoir engineering and geosciences. The hyper-dimensional system applies spatial volume interaction, voice control, real time collaboration and remote networking to perform reservoir engineering and geosciences.

The entire spatial volume is ‘active’ for reservoir and geosciences applications. In general, the present invention enables each point in the spatial volume for reservoir engineering and geosciences interactions. However, it is conceptually easier to work with virtual, that is hyper dimensional surfaces and media. Multiple instances of the hyper-dimensional simulation system are represented in a device appropriate nature. Physical objects can be used to perform pre-assigned reservoir engineering and geosciences functions. Voice commands (another hyper-dimension information and command interchanges with the simulation model and computer) are also used to perform reservoir engineering and geosciences functions.

The invention has been sufficiently described so that a person with average knowledge in the matter may reproduce and obtain the results mentioned in the invention herein Nonetheless, any skilled person in the field of technique, subject of the invention herein, may carry out modifications not described in the request herein, to apply these modifications to a determined structure, or in the manufacturing process of the same, requires the claimed matter in the following claims; such structures shall be covered within the scope of the invention.

It should be noted and understood that there can be improvements and modifications made of the present invention described in detail above without departing from the spirit or scope of the invention as set forth herein.

What is claimed is:

1. A data processing system for computerized simulation of reservoir data regarding a subsurface reservoir for reservoir engineering and geosciences analysis in response to commands communicated by a user, the data processing system comprising:
(a) a data memory containing reservoir data information for the reservoir being simulated;
(b) a viewing station sensing commands from the user for display of selected portions of the reservoir data;
(c) a processor performing the steps of:
(1) receiving from the data memory the selected portions of the reservoir data based on the commands from the user;
(2) transferring the selected portions of the reservoir data from the processor based on the commands from the user;
(d) an output display receiving the transferred selected portions of the reservoir data from the processor and forming an output image of the transferred selected portions of the reservoir data based on the commands from the user.

2. The data processing system of claim 1, wherein the user commands comprise voice commands.

3. The data processing system of claim 1, wherein the user commands comprise hand poses.

4. The data processing system of claim 1, wherein the user commands comprise hand gestures.

5. The data processing system of claim 1, wherein the output display comprises a display screen.

6. The data processing system of claim 1, wherein the output display comprises a virtual image projected on a surface in the viewing station.

7. The data processing system of claim 5, wherein the user commands comprise hand gestures toward the virtual image.

8. The data processing system of claim 1, wherein:
(a) the viewing station user senses a user command to move the output image of the data on the output display;
(b) the processor arranges the data for display in a moved position on the output display in response to the user command; and
(c) the output display forms an output image of the data in the moved position.

9. The data processing system of claim 1, wherein:
(a) the viewing station user senses a user command to restore an output image of the data on the output display;
(b) the processor arranges the data for display in a restored form on the output display in response to the user command; and
(c) the output display forms an output image of the data in the restored form.

10. The data processing system of claim 1, wherein:
(a) the viewing station user senses a user command to determine the possible presence of a well in the reservoir at a selected location in the reservoir;
(b) the processor arranges the data for display indicating the possible presence of the well in the reservoir at a selected location in the reservoir in response to the user command; and
(c) the output display forms an output image of the possible presence of the well in the reservoir.

11. The data processing system of claim 1, wherein:
(a) the viewing station user senses a user command to design a well in the reservoir at a selected location in the reservoir;
(b) the processor arranges the data for display indicating the designed well in the reservoir at a selected location in the reservoir in response to the user command; and
(c) the output display forms an output image of the designed well in the reservoir.

12. The data processing system of claim 1, wherein:
(a) the viewing station user senses a user command to select a well in the reservoir at a selected location in the reservoir;
(b) the processor arranges the data for display indicating the selected well in the reservoir at a selected location in the reservoir in response to the user command; and
(c) the output display forms an output image of the well at the selected location in the reservoir.

13. The data processing system of claim 1, wherein:
(a) the viewing station user senses a user command to track a well site in the reservoir at a selected location in the reservoir;
(b) the processor arranges the data for display indicating the tracked well site in the reservoir at a selected location in the reservoir in response to the user command; and
(c) the output display forms an output image of the tracked well site at the selected location in the reservoir.

14. The data processing system of claim 1, wherein:
(a) the viewing station user senses a user command to move to a different position in the reservoir;
(b) the processor arranges the data for display indicating the reservoir data at the different position in the reservoir in response to the user command; and
(c) the output display forms an output image of reservoir data at the different position in the reservoir.

15. The data processing system of claim 1, wherein:
(a) the viewing station user senses a user command to designate a selected region of interest in the reservoir;
(b) the processor arranges the data for display indicating the designated selected region of interest in the reservoir in response to the user command; and
(c) the output display forms an output image of reservoir data at the selected region of interest in the reservoir.

16. The data processing system of claim 1, wherein:
(a) the viewing station user senses a user command to display a selected property of interest in the reservoir;
(b) the processor arranges the data for display indicating the selected property of interest in the reservoir in response to the user command; and
(c) the output display forms an output image of the selected property of interest in the reservoir.

17. The data processing system of claim 1, wherein:
(a) the viewing station user senses a user command to display sweep of fluids over time in the reservoir;
(b) the processor arranges the data for display indicating the sweep of fluids over time in the reservoir in response to the user command; and
(c) the output display forms an output image of the sweep of fluids over time in the reservoir.

18. The data processing system of claim 1, wherein:
(a) the viewing station user senses a user command by placement of a physical object on a virtual image of the reservoir to indicate a subsurface object relating to an assigned activity of the reservoir;
(b) the processor arranges the data for display indicating the presence of the symbolized subsurface object in the reservoir in response to the user command; and
(c) the output display forms an output image of the symbolized subsurface object in the reservoir.

19. The data processing system of claim 1, wherein:
(a) the viewing station user senses a user command to run a reservoir simulation in the reservoir; and
(b) the processor arranges the data for display indicating the results of the reservoir simulation in the reservoir in response to the user command.

20. The data processing system of claim 1, wherein:
(a) the output display comprises a display screen;
(b) the output display further comprises a virtual image projected on a surface in the viewing station;
(c) the viewing station senses a user command to transfer a data display between the display screen and the virtual image; and
(d) the processor transfers data display between the display screen and the virtual image in response to the user command.

21. The data processing system of claim 1, wherein the reservoir data is selected from the group consisting of well test data and core data.

22. The data processing system of claim 1, wherein the reservoir data is selected from the group consisting of reservoir fluid characterization and reservoir properties.

23. The data processing system of claim 1, wherein the reservoir data is selected from the group consisting of seismic data and geologic data.

24. The data processing system of claim 1, further including:
a network interface connecting the processor to a computer communication network.

25. The data processing system of claim 1, wherein the viewing station receives and transfers information to the user in a spatial operating environment.

26. A computer implemented method of computerized simulation in a computer system including a processor, a data memory, a user interface and an output display, the computerized simulation being of reservoir data regarding a subsurface reservoir for reservoir engineering and geosciences analysis in response to commands communicated by a user, the computerized simulation method comprising the computer processing steps of:
(a) storing in the data memory reservoir data information for the reservoir being simulated;
(b) sensing in the viewing station commands from the user for display of selected portions of the reservoir data;
(c) receiving in the processor the selected portions of the reservoir data from the data memory based on the commands from the user;
(d) transferring to the output display the selected portions of the reservoir data received from the processor based on the commands from the user; and
(e) forming in the output display an output image of the transferred selected portions of the reservoir data based on the commands from the user.

27. The computer implemented method of claim 26, wherein the step of sensing comprises the step of sensing in the voice commands from the user.

28. The computer implemented method of claim 26, wherein the step of sensing comprises the step of sensing in the hand poses from the user.

29. The computer implemented method of claim 26, wherein the step of sensing comprises the step of sensing in the hand gestures from the user.

30. The computer implemented method of claim 26, wherein the step of forming an output image comprises forming an image on a display screen.

31. The computer implemented method of claim 26, wherein the step of forming an output image comprises forming a virtual image on a surface in the viewing station.

32. The computer implemented method of claim 31, wherein the step of sensing comprises sensing the hand gesture from the user toward the virtual image.

33. The computer implemented method of claim 26, wherein:
(a) the step of sensing comprises sensing a user command to move the output image of the data on the output display; and further including the steps of
(b) arranging the data in the processor for display in a moved position on the output display in response to the user command; and
(c) forming an output image on the output display of the data in the moved position.

34. The computer implemented method of claim 26, wherein:
(a) the step of sensing comprises sensing a user command to restore an output image of the data on the output display; and further including the steps of
(b) arranging the data in the processor for display in a restored position on the output display in response to the user command; and
(c) forming an output image on the output display of the data in the restored position.

35. The computer implemented method of claim 26, wherein:
(a) the step of sensing comprises sensing a user command to determine the possible presence of a well at a selected location in the reservoir; and further including the steps of
(b) arranging the data in the processor for display indicating the possible presence of a well at the selected location in response to the user command; and
(c) forming an output image on the output display indicating the possible presence of a well at the selected location in response to the user command.

36. The computer implemented method of claim 26, wherein:
(a) the step of sensing comprises sensing a user command to design a well at a selected location in the reservoir; and further including the steps of
(b) arranging the data in the processor for display indicating the designed well at the selected location in response to the user command; and
(c) forming an output image on the output display indicating designed well at the selected location in response to the user command.

37. The computer implemented method of claim 26, wherein:
(a) the step of sensing comprises sensing a user command to select a well at a selected location in the reservoir; and further including the steps of
(b) arranging the data in the processor for display indicating the selected well at the selected location in response to the user command; and
(c) forming an output image on the output display indicating selected well at the selected location in response to the user command.

38. The computer implemented method of claim 26, wherein:
(a) the step of sensing comprises sensing a user command to track a well site in the reservoir at a selected location; and further including the steps of
(b) arranging the data in the processor for display indicating the tracked well site at the selected location in response to the user command; and
(c) forming an output image on the output display indicating the tracked well at the selected location in response to the user command.

39. The computer implemented method of claim 26, wherein:
(a) the step of sensing comprises sensing a user command to move to a different position in the reservoir; and further including the steps of
(b) arranging the data in the processor for display indicating the reservoir data at the different position in response to the user command; and
(c) forming an output image on the output display indicating the reservoir data at the different position in response to the user command.

40. The computer implemented method of claim 26, wherein:
(a) the step of sensing comprises sensing a user command to designate a selected region of interest in the reservoir; and further including the steps of
(b) arranging the data in the processor for display indicating the selected region of interest in response to the user command; and
(c) forming an output image on the output display indicating the selected region of interest in response to the user command.

41. The computer implemented method of claim 26, wherein:
(a) the step of sensing comprises sensing a user command to display a selected property of interest in the reservoir; and further including the steps of
(b) arranging the data in the processor for display indicating the selected property of interest in response to the user command; and
(c) forming an output image on the output display indicating the selected property of interest in response to the user command.

42. The computer implemented method of claim 26, wherein:
(a) the step of sensing comprises sensing a user command to display sweep of fluids over time in the reservoir; and further including the steps of
(b) arranging the data in the processor for display indicating the sweep of fluids over time in the reservoir in response to the user command; and
(c) foaming an output image on the output display indicating the sweep of fluids over time in the reservoir in response to the user command.

43. The computer implemented method of claim 26, wherein:
(a) the step of sensing comprises sensing a user command by placement of a physical object symbolizing a subsurface object relating to an assigned activity of the reservoir; and further including the steps of
(b) arranging the data in the processor for display indicating the presence of the symbolized subsurface object in the reservoir in response to the user command; and
(c) forming an output image on the output display indicating the symbolized subsurface object in the reservoir in response to the user command.

44. The computer implemented method of claim 26, wherein:
(a) the step of sensing comprises sensing a user command to run a reservoir simulation in the reservoir; and further including the steps of
(b) arranging the data in the processor for display indicating the results of the reservoir simulation in response to the user command; and
(c) forming an output image on the output display indicating the symbolized subsurface object in the reservoir in response to the user command.

45. The computer implement method of claim 1, wherein the output display comprises a display screen and a virtual display on a surface in the viewing station, and wherein:
(a) the step of sensing comprises sensing a user command to transfer a data display between the display screen and the virtual image; and further including the step of
(b) transferring the data display between the display screen and the virtual image in response to the user command.

46. The computer implement method of claim 1, further including the step of transferring the reservoir data from the processor to a computer communication network.

47. A data storage device having stored in a non-transitory computer readable medium computer operable instructions for causing a data processing system comprising a processor, a data memory, a user interface and an output display to perform computerized simulation of reservoir data regarding a subsurface reservoir for reservoir engineering and geosciences analysis in response to commands communicated by a user, the instructions stored in the data storage device causing the data processing system to perform the following steps:
(a) storing in the data memory reservoir data information for the reservoir being simulated;
(b) sensing in the viewing station commands from the user for display of selected portions of the reservoir data;
(c) receiving in the processor the selected portions of the reservoir data from the data memory based on the commands from the user;
(d) transferring to the output display the selected portions of the reservoir data received from the processor based on the commands from the user; and
(e) forming in the output display an output image of the transferred selected portions of the reservoir data based on the commands from the user.

48. The data storage device of claim 47, wherein the instructions comprise:
(a) instructions causing the processor to arrange the data for display in a moved position on the output display in response to the user command; and
(b) instructions causing the output display to form an output image of the data in the moved position.

49. The data storage device of claim 47, wherein the instructions comprise:
(a) instructions causing the processor to arrange the data for display in a moved position on the output display in response to the user command; and
(b) instructions causing the output display to form an output image of the data in the moved position.

50. The data storage device of claim 47, wherein the instructions comprise:
(a) instructions causing the processor to arrange the data for display in a restored form on the output display in response to the user command; and
(b) instructions causing the output display to form an output image of the data in the restored form.

51. The data storage device of claim 47, wherein the instructions comprise:
(a) instructions causing the processor to arrange the data for display indicating the possible presence of the well in the reservoir at a selected location in the reservoir in response to the user command; and
(b) instructions causing the output display to form an output image of the possible presence of the well in the reservoir.

52. The data storage device of claim 47, wherein the instructions comprise:
(a) instructions causing the processor to arrange the data for display indicating the designed well in the reservoir at a selected location in the reservoir in response to the user command; and
(b) instructions causing the output display to form an output image of the designed well in the reservoir.

53. The data storage device of claim 47, wherein the instructions comprise:
(a) instructions causing the processor to arrange the data for display indicating the selected well in the reservoir at a selected location in the reservoir in response to the user command; and
(b) instructions causing the output display to form an output image of the well at the selected location in the reservoir.

54. The data storage device of claim 47, wherein the instructions comprise:
(a) instructions causing the processor to arrange s the data for display indicating the tracked well site in the reservoir at a selected location in the reservoir in response to the user command; and
(b) instructions causing the output display to form an output image of the tracked well site at the selected location in the reservoir.

55. The data storage device of claim 47, wherein the instructions comprise:
(a) instructions causing the processor to arrange the data for display indicating the reservoir data at the different position in the reservoir in response to the user command; and
(b) instructions causing the output display to form output image of reservoir data at the different position in the reservoir.

56. The data storage device of claim 47, wherein the instructions comprise:
(a) instructions causing the processor to arrange the data for display indicating the designated selected region of interest in the reservoir in response to the user command; and
(b) instructions causing the output display to form output image of reservoir data at the selected region of interest in the reservoir.

57. The data storage device of claim 47, wherein the instructions comprise:
(a) instructions causing the processor to arrange the data for display indicating the selected property of interest in the reservoir in response to the user command; and
(b) instructions causing the output display to form an output image of the selected property of interest in the reservoir.

58. The data storage device of claim 47, wherein the instructions comprise:
(a) instructions causing the processor to arrange the data for display indicating the sweep of fluids over time in the reservoir in response to the user command; and
(b) instructions causing the output display to form an output image of the sweep of fluids over time in the reservoir.

59. The data storage device of claim 47, wherein the instructions comprise:
(a) instructions causing the processor to arrange the data for display indicating the presence of a symbolized subsurface object in the reservoir in response to the user command; and
(b) instructions causing the output display to form an output image of the symbolized subsurface object in the reservoir.

60. The data storage device of claim 47, wherein the instructions comprise:
instructions causing the processor to arrange the data for display indicating the results of a reservoir simulation in the reservoir in response to the user command.

61. The data storage device of claim 47, wherein the output display comprises a display screen and a virtual image projected on a surface in the viewing station and the instructions comprise:
instructions causing the processor to transfer a data display between the display screen and the virtual image in response to a user command.

62. The data storage device of claim 47, wherein the instructions comprise:
instructions causing a network interface to connect the processor to a computer communication network.
